(19) United States
(12) Patent Application Publication
(10) Pub. No.: US 2026/0361852 A1
(43) Pub. Date: Nov. 12, 2026

(54) Diversifying Decoder-side Intra Mode Derivation Merge Candidates

(71) Applicant: Ofinno, LLC, Reston, VA (US)

(72) Inventors: Alexey Konstantinovich Filippov, Khimki (RU); Vasily Alexeevich Rufitskiy, Vladimir (RU); Esmael Hejazi Dinan, McLean, VA (US)

(73) Assignee: Ofinno, LLC, Reston, VA (US)

(21) Appl. No.: 19/724,045

(22) Filed: Jun. 29, 2026

Related U.S. Application Data
(63) Continuation of application No. PCT/US2024/062405, filed on Dec. 31, 2024.
(60) Provisional application No. 63/616,717, filed on Dec. 31, 2023.

(51) Int. Cl. H04N 19/105; H04N 19/159; H04N 19/176; H04N 19/196; H04N 19/593

(52) U.S. Cl. CPC H04N 19/105; H04N 19/159; H04N 19/176; H04N 19/196; H04N 19/593

(57) ABSTRACT

A video coder determines, based on a first indication of a decoder-side intra mode derivation (DIMD) prediction mode being enabled for coding a current block: a first histogram of gradients (HoG) based on the current block; and a second HoG based on a neighboring block of the current block. A value is determined representing a similarity between the first HoG and the second HoG. Based on comparing the value with a threshold value, a set of parameters is selected, from a first set of parameters and a second set of parameters, for the DIMD prediction mode. The coder codes the current block using a DIMD predictor generated based on the set of parameters.

### CROSS-REFERENCE TO RELATED APPLICATIONS

This application is a continuation of International Application No. PCT/US2024/062405, filed Dec. 31, 2024, which claims the benefit of U.S. Provisional Application No. 63/616,717, filed Dec. 31, 2023, all of which are hereby incorporated by reference in their entireties.

### BRIEF DESCRIPTION OF THE DRAWINGS

Some features are shown by way of example, and not by limitation, in the accompanying drawings. In the drawings, like numerals reference similar elements.

FIG. 1 shows an example video coding/decoding system in which embodiments of the present disclosure may be implemented.

FIG. 2 shows an example encoder in which embodiments of the present disclosure may be implemented.

FIG. 3 shows an example decoder in which embodiments of the present disclosure may be implemented.

FIG. 4 shows an example quadtree partitioning of a coding tree block (CTB).

FIG. 5 shows an example quadtree corresponding to the example quadtree partitioning of the CTB in FIG. 4.

FIG. 6 shows examples of binary tree and ternary tree partitions.

FIG. 7 shows an example of combined quadtree and multi-type tree partitioning of a CTB.

FIG. 8 shows an example tree corresponding to the combined quadtree and multi-type tree partitioning of the CTB shown in FIG. 7.

FIG. 9 shows an example set of reference samples determined for intra prediction of a current block.

FIGS. 10A and 10B show example intra prediction modes.

FIG. 11 shows an example of a current block and corresponding reference samples.

FIG. 12 shows an example of applying an intra prediction mode (e.g., an angular mode) for prediction of a current block.

FIG. 13A shows an example of inter prediction performed for a current block in a current picture.

FIG. 13B shows an example motion vector.

FIG. 14 shows an example of bi-prediction performed for a current block.

FIG. 15A shows example spatial candidate neighboring blocks relative to a current block being coded.

FIG. 15B shows example locations of two temporal, co-located blocks relative to a current block.

FIG. 16 shows an example of intra block copy (IBC).

FIG. 17 shows an example of template-based intra mode derivation (TIMD) for coding a current block, according to some embodiments.

FIG. 18 shows an example of signaling TIMD for decoding a current block, according to some embodiments.

FIG. 19 shows an example of decoder-side intra mode derivation (DIMD) template zone for computing a histogram of gradients (HoG), according to some embodiments.

FIG. 20 shows a flowchart of an example process for DIMD predictor derivation, according to some embodiments.

FIG. 21 shows an example prediction fusion by weighted averaging of two HoG modes and planar mode, according to some embodiments.

FIG. 22 shows a flowchart of an example process for DIMD merge mode, according to some embodiments.

FIG. 23 shows example spatial adjacent neighboring blocks considered in the derivation of the list of DIMD merge candidates, according to some embodiments.

FIG. 24 shows example spatial non-adjacent neighboring blocks used to derive DIMD merge candidates, according to some embodiments.

FIG. 25 shows a flowchart of an example process for adding DIMD information from spatial neighboring blocks to the history-based DIMD table, according to some embodiments.

FIG. 26 shows a flowchart of an example process for deriving an index into the list of DIMD merge candidates, according to some embodiments.

FIG. 27 shows example histograms of gradients (HoGs) for a plurality of DIMD modes and DIMD merge mode, according to some embodiments.

FIG. 28 shows example HoGs for DIMD mode and DIMD merge mode including similar HoGs for DIMD modes signaled according to flags or indications in a bitstream, according to some embodiments.

FIG. 29 shows a flowchart of an example process for diversifying decoder-side intra mode derivation (DIMD) merge candidates, according to some embodiments.

FIG. 30 shows an example of multiple reference lines (MRLs) with respect to a predicted block being coded in a DIMD mode, according to some embodiments.

FIG. 31 shows a flowchart of a method for diversifying decoder-side intra mode derivation (DIMD) merge candidates by a decoder, according to some embodiments.

FIG. 32 shows a flowchart of a method for diversifying decoder-side intra mode derivation (DIMD) merge candidates by an encoder, according to some embodiments.

FIG. 33 shows a block diagram of an example computer system in which embodiments of the present disclosure may be implemented.

### DETAILED DESCRIPTION

In the following description, numerous specific details are set forth in order to provide a thorough understanding of the disclosure. However, it will be apparent to those skilled in the art that the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s) may perform the necessary tasks.

A video sequence, comprising multiple pictures/frames, may be represented in digital form for storage and/or transmission. Representing a video sequence in digital form may require a large quantity of bits. Large data sizes that may be associated with video sequences may require significant resources for storage and/or transmission. Video encoding may be used to compress a size of a video sequence for more efficient storage and/or transmission. Video decoding may be used to decompress a compressed video sequence for display and/or other forms of consumption.

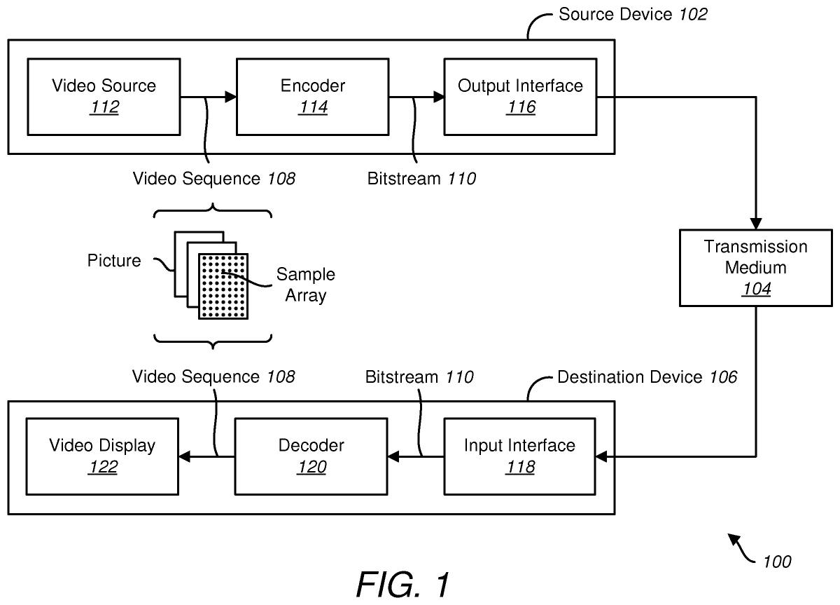

FIG. 1 shows an example video coding/decoding system 100 in which embodiments of the present disclosure may be implemented. Video coding/decoding system 100 comprises a source device 102, a transmission medium 104, and a destination device 106. Source device 102 encodes a video sequence 108 into a bitstream 110 for more efficient storage and/or transmission. Source device 102 may store and/or send/transmit bitstream 110 to destination device 106 via transmission medium 104. Destination device 106 decodes bitstream 110 to display video sequence 108. Destination device 106 may receive bitstream 110 from source device 102 via transmission medium 104. Source device 102 and/or destination device 106 may be any of a plurality of different devices (e.g., a desktop computer, laptop computer, tablet computer, smart phone, wearable device, television, camera, video gaming console, set-top box, video streaming device, etc.).

Source device 102 may comprise (e.g., for encoding video sequence 108 into bitstream 110) one or more of a video source 112, an encoder 114, and/or an output interface 116. Video source 112 may provide and/or generate video sequence 108 based on a capture of a natural scene and/or a synthetically generated scene. A synthetically generated scene may be a scene comprising computer generated graphics and/or screen content. Video source 112 may comprise a video capture device (e.g., a video camera), a video archive comprising previously captured natural scenes and/or synthetically generated scenes, a video feed interface to receive captured natural scenes and/or synthetically generated scenes from a video content provider, and/or a processor to generate synthetic scenes.

A video sequence, such as video sequence 108, may comprise a series of pictures (also referred to as frames). A video sequence may achieve an impression of motion based on successive presentation of pictures of the video sequence using a constant time interval or variable time intervals between the pictures. A picture may comprise one or more sample arrays of intensity values. The intensity values may be taken (e.g., measured, determined, provided) at a series of regularly spaced locations within a picture. A color picture may comprise (e.g., typically comprises) a luminance sample array and two chrominance sample arrays. The luminance sample array may comprise intensity values representing the brightness (e.g., luma component, Y) of a picture. The chrominance sample arrays may comprise intensity values that respectively represent the blue and red components of a picture (e.g., chroma components, Cb and Cr) separate from the brightness. Other color picture sample arrays may be possible based on different color schemes (e.g., a red, green, blue (RGB) color scheme). A pixel, in a color picture, may refer to/comprise/be associated with all intensity values (e.g., luma component, chroma components), for a given location, in the sample arrays (e.g., three sample arrays are used for one luma component and two chroma components, respectively) used to represent color pictures. A monochrome picture may comprise a single, luminance sample array. A pixel, in a monochrome picture, may refer to/comprise/be associated with the intensity value (e.g., luma component) at a given location in the single, luminance sample array used to represent monochrome pictures.

Encoder 114 may encode video sequence 108 into bitstream 110. Encoder 114 may apply/use (e.g., to encode video sequence 108) one or more prediction techniques to reduce redundant information in video sequence 108. Redundant information is information that may be predicted at a decoder and need not be transmitted to the decoder for accurate decoding of video sequence 108. For example, encoder 114 may apply spatial prediction (e.g., intra-frame or intra prediction), temporal prediction (e.g., inter-frame prediction or inter prediction), inter-layer prediction, and/or other prediction techniques to reduce redundant information in video sequence 108. Encoder 114 may partition pictures comprising video sequence 108 into rectangular regions referred to as blocks, for example, before applying one or more prediction techniques. Encoder 114 may then encode a block using the one or more of the prediction techniques.

For temporal prediction, encoder 114 may search for a block similar to the block being encoded in another picture (e.g., referred to as a reference picture) of video sequence 108. The block determined during the search (e.g., referred to as a prediction block) may then be used to predict the block being encoded. For spatial prediction, encoder 114 may form a prediction block based on data from reconstructed neighboring samples of the block to be encoded within the same picture of video sequence 108. A reconstructed sample refers to a sample that was encoded and then decoded. Encoder 114 may determine a prediction error (e.g., also referred to as a residual) based on the difference between a block being encoded and a prediction block. The prediction error may represent non-redundant information that may be sent/transmitted to a decoder for accurate decoding of video sequence 108.

Encoder 114 may apply a transform to the prediction error (e.g. using a discrete cosine transform (DCT), or any other transform) to generate transform coefficients. Encoder 114 may form bitstream 110 based on the transform coefficients and other information used to determine prediction blocks using/based on prediction types, motion vectors, and/or prediction modes. Encoder 114 may perform one or more of quantization and entropy coding of the transform coefficients and/or the other information used to determine the prediction blocks, for example, before forming bitstream 110. The quantization and/or the entropy coding may further reduce the quantity of bits needed to store and/or transmit video sequence 108.

Output interface 116 may be configured to write and/or store bitstream 110 onto transmission medium 104 for transmission to destination device 106. In addition or alternatively, output interface 116 may be configured to send/transmit, upload, and/or stream bitstream 110 to destination device 106 via transmission medium 104. Output interface 116 may comprise a wired and/or a wireless transmitter configured to send/transmit, upload, and/or stream bitstream 110 in accordance with one or more proprietary, open-source, and/or standardized communication protocols (e.g., Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, 3rd Generation Partnership Project (3GPP) standards, Institute of Electrical and Electronics Engineers (IEEE) standards, Internet Protocol (IP) standards, Wireless Application Protocol (WAP) standards, and/or any other communication protocol).

Transmission medium 104 may comprise wireless, wired, and/or computer readable medium. For example, transmission medium 104 may comprise one or more wires, cables, air interfaces, optical discs, flash memory, and/or magnetic memory. In addition or alternatively, transmission medium 104 may comprise one or more networks (e.g., the internet) or file servers configured to store and/or send/transmit encoded video data.

Destination device 106 may decode bitstream 110 into video sequence 108 for display. Destination device 106 may comprise one or more of an input interface 118, a decoder 120, and/or a video display 122. Input interface 118 may be configured to read bitstream 110 stored on transmission medium 104 by source device 102. In addition or alternatively, input interface 118 may be configured to receive, download, and/or stream bitstream 110 from source device 102 via transmission medium 104. Input interface 118 may comprise a wired and/or a wireless receiver configured to receive, download, and/or stream bitstream 110 in accordance with one or more proprietary, open-source, standardized communication protocols, and/or any other communication protocol (e.g., such as referenced herein).

Decoder 120 may decode video sequence 108 from encoded bitstream 110. The decoder 120 may generate prediction blocks for pictures of video sequence 108 in a similar manner as encoder 114 and determine the prediction errors for the blocks, for example, to decode video sequence 108. Decoder 120 may generate the prediction blocks using/based on prediction types, prediction modes, and/or motion vectors received in bitstream 110. Decoder 120 may determine the prediction errors using the transform coefficients received in bitstream 110. Decoder 120 may determine the prediction errors by weighting transform basis functions using the transform coefficients. Decoder 120 may combine the prediction blocks and the prediction errors to decode video sequence 108. Video sequence 108 at the destination device 106 may be, or may not necessarily be, the same video sequence sent, such as video sequence 108 as sent by the source device 102. Decoder 120 may decode a video sequence that approximates video sequence 108, for example, because of lossy compression of video sequence 108 by encoder 114 and/or errors introduced into encoded bitstream 110 during transmission to destination device 106.

Video display 122 may display video sequence 108 to a user. Video display 122 may comprise a cathode ray tube (CRT) display, a liquid crystal display (LCD), a plasma display, a light emitting diode (LED) display, and/or any other display device suitable for displaying video sequence 108.

Video coding/decoding system 100 is merely an example and video encoding/decoding systems different from the video coding/decoding system 100 and/or modified versions of the video coding/decoding system 100 may similarly perform the methods and processes as described herein. For example, the video coding/decoding system 100 may comprise other components and/or arrangements. For example, video source 112 may be external to source device 102. Similarly, video display 122 may be external to destination device 106 or omitted altogether (e.g., if video sequence 108 is intended for consumption by a machine and/or storage device). In an example, source device 102 may further comprise a video decoder and destination device 106 may further comprise a video encoder. For example, source device 102 may be configured to further receive an encoded bitstream from destination device 106 to support two-way video transmission between the devices.

Encoder 114 and/or decoder 120 may operate according to one or more proprietary or industry video coding standards. For example, encoder 114 and/or decoder 120 may operate in accordance with one or more proprietary, open-source, and/or standardized protocols (e.g., International Telecommunications Union Telecommunication Standardization Sector (ITU-T) H.263, ITU-T H.264 and Moving Picture Expert Group (MPEG)-4 Visual (also known as Advanced Video Coding (AVC)), ITU-T H.265 and MPEG-H Part 2 (also known as High Efficiency Video Coding (HEVC)), ITU-T H.265 and MPEG-I Part 3 (also known as Versatile Video Coding (VVC), the WebM VP8 and VP9 codecs, and/or AOMedia Video 1 (AV1), and/or any other video coding protocol).

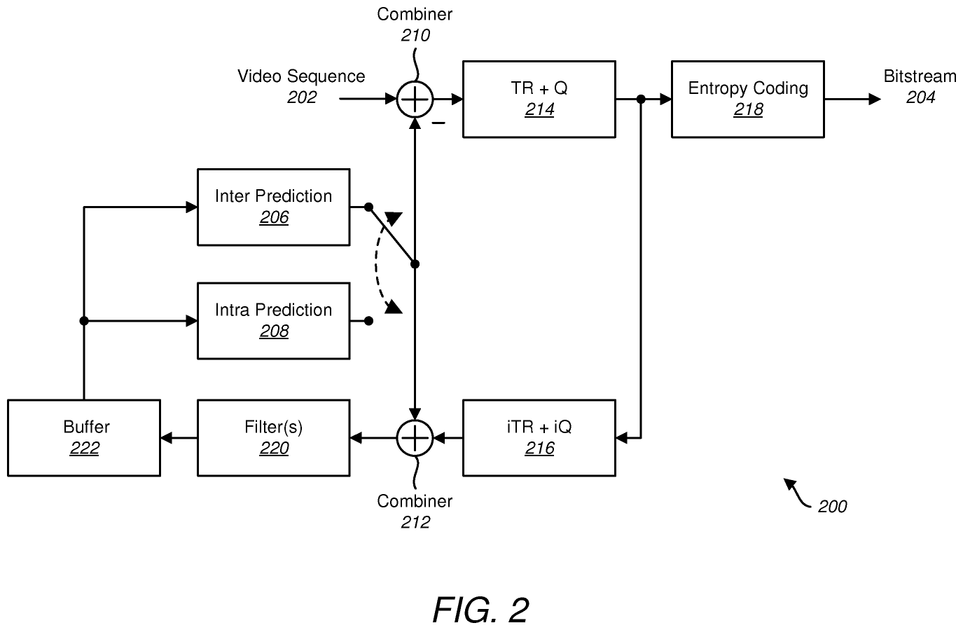

FIG. 2 shows an example encoder. Encoder 200 as shown in FIG. 2 may implement one or more processes described herein. Encoder 200 may encode a video sequence 202 into a bitstream 204 for more efficient storage and/or transmission. Encoder 200 may be implemented in video coding/decoding system 100 as shown in FIG. 1 (e.g., as encoder 114) or in any computing, communication, or electronic device (e.g., desktop computer, laptop computer, tablet computer, smart phone, wearable device, television, camera, video gaming console, set-top box, video streaming device, etc.). Encoder 200 may comprise one or more of an inter prediction unit 206, an intra prediction unit 208, combiners 210 and 212, a transform and quantization unit (TR+Q) 214, an inverse transform and quantization unit (iTR+iQ) 216, an entropy coding unit 218, one or more filters 220, and/or a buffer 222.

Encoder 200 may partition pictures (e.g., frames) of (e.g., comprising) video sequence 202 into blocks and encode video sequence 202 on a block-by-block basis. Encoder 200 may perform/apply a prediction technique on a block being encoded using either inter prediction unit 206 or intra prediction unit 208. Inter prediction unit 206 may perform inter prediction by searching for a block similar to the block being encoded in another, reconstructed picture (e.g., a reference picture) of video sequence 202. A reconstructed picture refers to a picture that was encoded and then decoded. The block determined during the search (e.g., referred to as a prediction block) may then be used to predict the block being encoded to remove redundant information. Inter prediction unit 206 may exploit temporal redundancy or similarities in scene content from picture to picture in video sequence 202 to determine the prediction block. For example, scene content between pictures of video sequence 202 may be similar except for differences due to motion and/or affine transformation of the screen content over time.

Intra prediction unit 208 may perform intra prediction by forming a prediction block based on data from reconstructed neighboring samples of the block to be encoded within the same picture of video sequence 202. A reconstructed sample refers to a sample that was encoded and then decoded. Intra prediction unit 208 may exploit spatial redundancy or similarities in scene content within a picture of video sequence 202 to determine the prediction block. For example, the texture of a region of scene content in a picture may be similar to the texture in the immediate surrounding area of the region of the scene content in the same picture.

Combiner 210 may determine a prediction error (e.g., referred to as a residual) based on the difference between the block being encoded and the prediction block. The prediction error may represent non-redundant information that may be sent/transmitted to a decoder for accurate decoding of video sequence 202.

Transform and quantization unit (TR+Q) 214 may transform and quantize the prediction error. Transform and quantization unit 214 may transform the prediction error into transform coefficients by applying, for example, a DCT to reduce correlated information in the prediction error. Transform and quantization unit 214 may quantize the coefficients by mapping data of the transform coefficients to a predefined set of representative values. Transform and quantization unit 214 may quantize the coefficients to reduce irrelevant information in bitstream 204. The irrelevant information refers to information that may be removed from the coefficients without producing visible and/or perceptible distortion in video sequence 202 after decoding (e.g., at a receiving device).

Entropy coding unit 218 may apply one or more entropy coding methods to the quantized transform coefficients to further reduce the bit rate. For example, entropy coding unit 218 may apply context adaptive variable length coding (CAVLC), context adaptive binary arithmetic coding (CABAC), and/or syntax-based context-based binary arithmetic coding (SBAC). The entropy coded coefficients may be packed to form bitstream 204.

Inverse transform and quantization unit (iTR+iQ) 216 may inverse quantize and inverse transform the quantized transform coefficients to determine a reconstructed prediction error. Combiner 212 may combine the reconstructed prediction error with the prediction block to form a reconstructed block. Filter(s) 220 may filter the reconstructed block, for example, using a deblocking filter and/or a sample-adaptive offset (SAO) filter. Buffer 222 may store the reconstructed block for prediction of one or more other blocks in the same and/or different picture of video sequence 202.

Encoder 200 may further comprise an encoder control unit. The encoder control unit may be configured to control one or more units of encoder 200 as shown in FIG. 2. The encoder control unit may control the one or more units of encoder 200 such that bitstream 204 may be generated in conformance with the requirements of one or more proprietary coding protocols, industry video coding standards, and/or any other video coding protocol. For example, the encoder control unit may control the one or more units of encoder 200 such that bitstream 204 may be generated in conformance with one or more of ITU-T H.263, AVC, HEVC, VVC, VP8, VP9, AV1, and/or any other video coding standard/format.

The encoder control unit may be configured to attempt to minimize (or reduce) the bitrate of bitstream 204 and/or maximize (or increase) the reconstructed video quality (e.g., within the constraints of a proprietary coding protocol, industry video coding standard, and/or any other video coding protocol). For example, the encoder control unit may be configured to attempt to minimize or reduce the bitrate of bitstream 204 such that the reconstructed video quality does not fall below a certain level/threshold, and/or to maximize or increase the reconstructed video quality such that the bitrate of bitstream 204 does not exceed a certain level/threshold. The encoder control unit may determine/control one or more of: partitioning of the pictures of video sequence 202 into blocks, whether a block is inter predicted by inter prediction unit 206 or intra predicted by intra prediction unit 208, a motion vector for inter prediction of a block, an intra prediction mode among a plurality of intra prediction modes for intra prediction of a block, filtering performed by filter(s) 220, and/or one or more transform types and/or quantization parameters applied by transform and quantization unit 214. The encoder control unit may determine/control one or more of the above based on a rate-distortion measure for a block or picture being encoded. The encoder control unit may determine/control one or more of the above to reduce the rate-distortion measure for a block or picture being encoded.

The prediction type used to encode a block (intra or inter prediction), prediction information of the block (intra prediction mode if intra predicted, motion vector, etc.), and/or transform and/or quantization parameters, may be sent to entropy coding unit 218 to be further compressed (e.g., to reduce the bitrate). For example, entropy coding unit 218 may apply context adaptive variable length coding (CAVLC), context adaptive binary arithmetic coding (CABAC), and/or syntax-based context-based binary arithmetic coding (SBAC) to achieve further compression. The prediction type, prediction information, and/or transform and/or quantization parameters may be packed with the prediction error to form bitstream 204.

Encoder 200 is merely an example and encoders different from encoder 200 and/or modified versions of encoder 200 may perform the methods and processes as described herein. For example, encoder 200 may comprise other components and/or arrangements. One or more of the components shown in FIG. 2 may be optionally included in encoder 200 (e.g., entropy coding unit 218 and/or filters(s) 220).

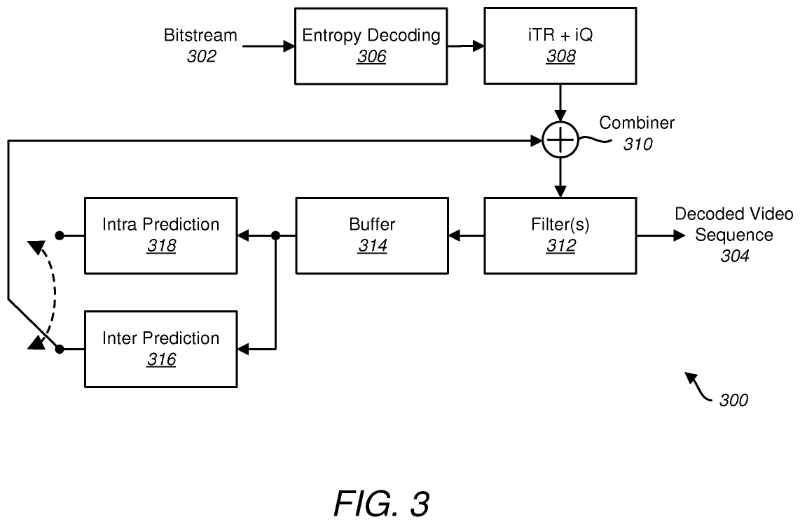

FIG. 3 shows an example decoder. A decoder 300 as shown in FIG. 3 may implement one or more processes described herein. Decoder 300 may decode a bitstream 302 into a decoded video sequence 304 for display and/or some other form of consumption. Decoder 300 may be implemented in video coding/decoding system 100 in FIG. 1 and/or in a computing, communication, or electronic device (e.g., desktop computer, laptop computer, tablet computer, smart phone, wearable device, television, camera, video gaming console, set-top box, and/or video streaming device). Decoder 300 may comprise an entropy decoding unit 306, an inverse transform and quantization (iTR+iQ) unit 308, a combiner 310, one or more filters 312, a buffer 314, an inter prediction unit 316, and/or an intra prediction unit 318.

Decoder 300 may comprise a decoder control unit configured to control one or more units of decoder 300. The decoder control unit may control the one or more units of decoder 300 such that bitstream 302 is decoded in conformance with the requirements of one or more proprietary coding protocols, industry video coding standards, and/or any other communication protocol. For example, the decoder control unit may control the one or more units of decoder 300 such that the bitstream 302 is decoded in conformance with one or more of ITU-T H.263, AVC, HEVC, VVC, VP8, VP9, AV1, and/or any other video coding standard/format.

The decoder control unit may determine/control one or more of: whether a block is inter predicted by inter prediction unit 316 or intra predicted by intra prediction unit 318, a motion vector for inter prediction of a block, an intra prediction mode among a plurality of intra prediction modes for intra prediction of a block, filtering performed by filter(s) 312, and/or one or more inverse transform types and/or inverse quantization parameters to be applied by inverse transform and quantization unit 308. One or more of the control parameters used by the decoder control unit may be packed in bitstream 302.

Entropy decoding unit 306 may entropy decode the bitstream 302. For example, entropy decoding unit 306 may apply context adaptive variable length coding (CAVLC), context adaptive binary arithmetic coding (CABAC), and syntax-based context-based binary arithmetic coding (SBAC) to decompress the prediction type used to encode a block (intra or inter prediction), prediction information of the block (intra prediction mode if intra predicted, motion vector, etc.), and transform and quantization parameters. Inverse transform and quantization unit 308 may inverse quantize and/or inverse transform the quantized transform coefficients to determine a decoded prediction error. Combiner 310 may combine the decoded prediction error with a prediction block to form a decoded block. The prediction block may be generated by intra prediction unit 318 or inter prediction unit 316 (e.g., as described above with respect to encoder 200 in FIG. 2). Filter(s) 312 may filter the decoded block, for example, using a deblocking filter and/or a sample-adaptive offset (SAO) filter. Buffer 314 may store the decoded block for prediction of one or more other blocks in the same and/or different picture of the video sequence in bitstream 302. Decoded video sequence 304 may be output from filter(s) 312 as shown in FIG. 3.

Decoder 300 is merely an example and decoders different from decoder 300 and/or modified versions of decoder 300 may perform the methods and processes as described herein. For example, decoder 300 may have other components and/or arrangements. One or more of the components shown in FIG. 3 may be optionally included in decoder 300 (e.g., entropy decoding unit 306 and/or filters(s) 312).

Although not shown in FIGS. 2 and 3, each of encoder 200 and decoder 300 may further comprise an intra block copy unit in addition to inter prediction and intra prediction units. The intra block copy unit may perform/operate similar to an inter prediction unit but may predict blocks within the same picture. For example, the intra block copy unit may exploit repeated patterns that appear in screen content. The screen content may include computer generated text, graphics, animation, etc.

Video encoding and/or decoding may be performed on a block-by-block basis. The process of partitioning a picture into blocks may be adaptive based on the content of the picture. For example, larger block partitions may be used in areas of a picture with higher levels of homogeneity to improve coding efficiency.

A picture (e.g., in HEVC, or any other coding standard/format) may be partitioned into non-overlapping square blocks, which may be referred to as coding tree blocks (CTBs). The CTBs may comprise samples of a sample array. A CTB may have a size of 2n×2n samples, where n may be specified by a parameter of the encoding system. For example, n may be 4, 5, 6, or any other value. A CTB may have any other size. A CTB may be further partitioned by a recursive quadtree partitioning into coding blocks (CBs) of half vertical and half horizontal size. The CTB may form the root of the quadtree. A CB that is not split further as part of the recursive quadtree partitioning may be referred to as a leaf CB of the quadtree, and otherwise may be referred to as a non-leaf CB of the quadtree. A CB may have a minimum size specified by a parameter of the encoding system. For example, a CB may have a minimum size of 4×4, 8×8, 16×16, 32×32, 64×64 samples, or any other minimum size. A CB may be further partitioned into one or more prediction blocks (PBs) for performing inter and/or intra prediction. A PB may be a rectangular block of samples on which the same prediction type/mode may be applied. For transformations, a CB may be partitioned into one or more transform blocks (TBs). A TB may be a rectangular block of samples that may determine/indicate an applied transform size.

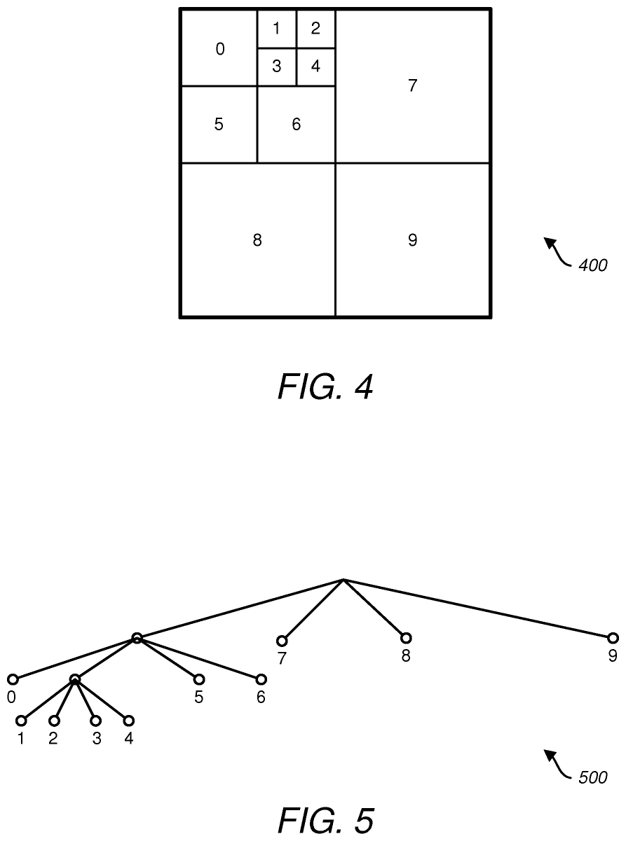

FIG. 4 shows an example quadtree partitioning of a CTB 400. FIG. 5 shows an example quadtree 500 corresponding to the example quadtree partitioning of CTB 400 in FIG. 4. As shown in the examples of FIGS. 4 and 5, CTB 400 may first be partitioned into four CBs of half vertical and half horizontal size. Three of the resulting CBs of the first level partitioning of CTB 400 are leaf CBs. The three leaf CBs of the first level partitioning of CTB 400 are respectively labeled 7, 8, and 9 in FIGS. 4 and 5. The non-leaf CB of the first level partitioning of CTB 400 is partitioned into four sub-CBs of half vertical and half horizontal size. Three of the resulting sub-CBs of the second level partitioning of CTB 400 are leaf CBs. The three leaf CBs of the second level partitioning of CTB 400 are respectively labeled 0, 5, and 6 in FIGS. 4 and 5. Finally, the non-leaf CB of the second level partitioning of CTB 400 is partitioned into four leaf CBs of half vertical and half horizontal size. The four leaf CBs are respectively labeled 1, 2, 3, and 4 in FIGS. 4 and 5.

The example CTB 400 of FIG. 4 is partitioned into 10 leaf CBs respectively labeled 0-9, but may be partitioned into other quantities of leaf CBs. The 10 leaf CBs may correspond to 10 CB leaf nodes (e.g., 10 CB leaf nodes of quadtree 500 as shown in FIG. 5). In other examples, a CTB may be partitioned into a different number of leaf CBs. The resulting quadtree partitioning of CTB 400 may be scanned using a z-scan (e.g., left-to-right, top-to-bottom) to form the sequence order for encoding/decoding the CB leaf nodes. A numeric label (e.g., indicator, index) of each CB leaf node in FIGS. 4 and 5 may correspond to the sequence order for encoding/decoding. For example, CB leaf node 0 may be encoded/decoded first and CB leaf node 9 may be encoded/decoded last. Although not shown in FIGS. 4 and 5, each CB leaf node may comprise one or more PBs and/or TBS.

A picture, in VVC (or in any other coding standard/format), may be partitioned in a similar manner (such as in HEVC). A picture may be first partitioned into non-overlapping square CTBs. The CTBs may then be partitioned, using a recursive quadtree partitioning, into CBs of half vertical and half horizontal size. A quadtree leaf node (e.g., in VVC) may be further partitioned by a binary tree or ternary tree partitioning (or any other partitioning) into CBs of unequal sizes.

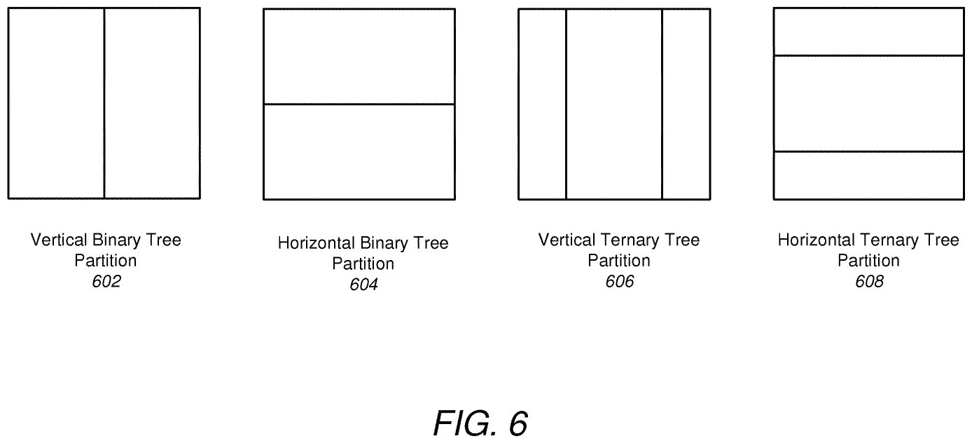

FIG. 6 shows example binary tree and ternary tree partitions. A binary tree partition may divide a parent block in half in either a vertical direction 602 or a horizontal direction 604. The resulting partitions may be half in size as compared to the parent block. In other examples, the resulting partitions may correspond to sizes that are less than and/or greater than half of the parent block size. A ternary tree partition may divide a parent block into three parts in either a vertical direction 606 or a horizontal direction 608. FIG. 6 shows an example in which the middle partition may be twice as large as the other two end partitions in the ternary tree partitions. In other examples, partitions may be of other sizes relative to each other and to the parent block. Binary and ternary tree partitions are examples of multi-type tree partitioning. Multi-type tree partitions may comprise partitioning a parent block into other quantities of smaller blocks. The block partitioning strategy (e.g., in VVC) may be referred to as a combination of quadtree and multi-type tree partitioning (quadtree+multi-type tree partitioning) because of the addition of binary and/or ternary tree partitioning to quadtree partitioning.

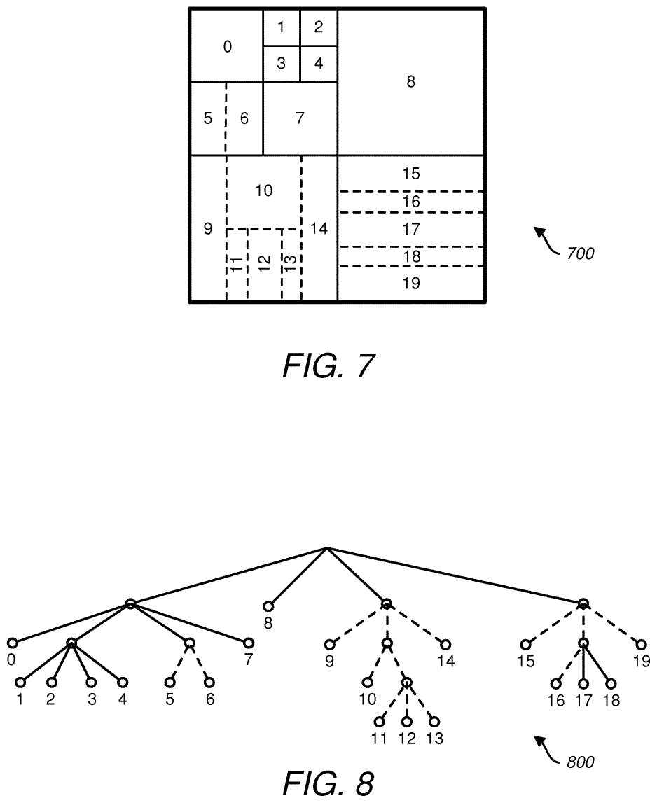

FIG. 7 shows an example of combined quadtree and multi-type tree partitioning of a CTB 700. FIG. 8 shows an example tree 800 corresponding to the combined quadtree and multi-type tree partitioning of CTB 700 shown in FIG. 7. In both FIGS. 7 and 8, quadtree splits are shown in solid lines and multi-type tree splits are shown in dashed lines. For ease of explanation, CTB 700 is shown with the same quadtree partitioning as the CTB 400 described in FIG. 4, and a description of the quadtree partitioning of CTB 700, which is similar to that for CTB 400, is omitted. The quadtree partitioning of the CTB 700 is merely an example and a CTB may be quadtree partitioned in a manner different from the CTB 700. Additional multi-type tree partitions of CTB 700 may be made relative to three leaf CBs shown in FIG. 4. The three leaf CBs in FIG. 4 that are shown in FIG. 7 as being further partitioned may be leaf CBs 5, 8, and 9. The three leaf CBs may be further partitioned using one or more binary and/or ternary tree partitions.

The leaf CB 5 of FIG. 4 may be partitioned into two CBs based on a vertical binary tree partitioning. The two resulting CBs may be leaf CBs respectively labeled 5 and 6 in FIGS. 7 and 8. The leaf CB 8 of FIG. 4 may be partitioned into three CBs based on a vertical ternary tree partition. Two of the three resulting CBs may be leaf CBS respectively labeled 9 and 14 in FIGS. 7 and 8. The remaining, non-leaf CB may be partitioned first into two CBs based on a horizontal binary tree partition. One of the two CBs may be a leaf CB labeled 10. The other of the two CBs may be further partitioned into three CBs based on a vertical ternary tree partition. The resulting three CBs may be leaf CBs respectively labeled 11, 12, and 13 in FIGS. 7 and 8. The leaf CB 9 of FIG. 4 may be partitioned into three CBs based on a horizontal ternary tree partition. Two of the three CBs may be leaf CBs respectively labeled 15 and 19 in FIGS. 7 and 8. The remaining, non-leaf CB may be partitioned into three CBs based on another horizontal ternary tree partition. The resulting three CBs may all be leaf CBs respectively labeled 16, 17, and 18 in FIGS. 7 and 8.

Altogether, CTB 700 may be partitioned into 20 leaf CBs respectively labeled 0-19. The 20 leaf CBs may correspond to 20 leaf nodes (e.g., 20 leaf nodes of tree 800 shown in FIG. 8). The resulting combination of quadtree and multi-type tree partitioning of the CTB 700 may be scanned using a z-scan (left-to-right, top-to-bottom) to form the sequence order for encoding/decoding the CB leaf nodes. A numeric label of each CB leaf node in FIGS. 7 and 8 may correspond to the sequence order for encoding/decoding, with CB leaf node 0 encoded/decoded first and CB leaf node 19 encoded/decoded last. Although not shown in FIGS. 7 and 8, it should be noted that each CB leaf node may comprise one or more PBs and/or TBS.

A coding standard/format (e.g., HEVC, VVC, or any other coding standard/format) may define various units (e.g., in addition to specifying various blocks (e.g., CTBs, CBS, PBs, TBs)). Blocks may comprise a rectangular area of samples in a sample array. Units may comprise the collocated blocks of samples from the different sample arrays (e.g., luma and chroma sample arrays) that form a picture as well as syntax elements and prediction data of the blocks. A coding tree unit (CTU) may comprise the collocated CTBs of the different sample arrays and may form a complete entity in an encoded bitstream. A coding unit (CU) may comprise the collocated CBs of the different sample arrays and syntax structures used to code the samples of the CBs. A prediction unit (PU) may comprise the collocated PBs of the different sample arrays and syntax elements used to predict the PBs. A transform unit (TU) may comprise TBs of the different samples arrays and syntax elements used to transform the TBs.

A block may refer to any of a CTB, CB, PB, TB, CTU, CU, PU, and/or TU (e.g., in the context of HEVC, VVC, or any other coding format/standard). A block may be used to refer to similar data structures in the context of any video coding format/standard/protocol. For example, a block may refer to a macroblock in the AVC standard, a macroblock or a sub-block in the VP8 coding format, a superblock or a sub-block in the VP9 coding format, and/or a superblock or a sub-block in the AV1 coding format.

In intra prediction, samples of a block to be encoded (e.g., also referred to as a current block) may be predicted from samples of the column immediately adjacent to the left-most column of the current block and samples of the row immediately adjacent to the top-most row of the current block. The samples from the immediately adjacent column and row may be jointly referred to as reference samples. Each sample of the current block may be predicted (e.g., in an intra prediction mode) by projecting the position of the sample in the current block in a given direction to a point along the reference samples. The sample may be predicted by interpolating between the two closest reference samples of the projection point if the projection does not fall directly on a reference sample. A prediction error (e.g., referred to as a residual) may be determined for the current block based on differences between the predicted sample values and the original sample values of the current block.

Predicting samples and determining a prediction error based on a difference between the predicted samples and original samples may be performed (e.g., at an encoder) for a plurality of different intra prediction modes (e.g., including non-directional intra prediction modes). The encoder may select one of the plurality of intra prediction modes and its corresponding prediction error to encode the current block. The encoder may send an indication of the selected prediction mode and its corresponding prediction error to a decoder for decoding of the current block. The decoder may decode the current block by predicting the samples of the current block, using the intra prediction mode indicated by the encoder, and/or combining the predicted samples with the prediction error.

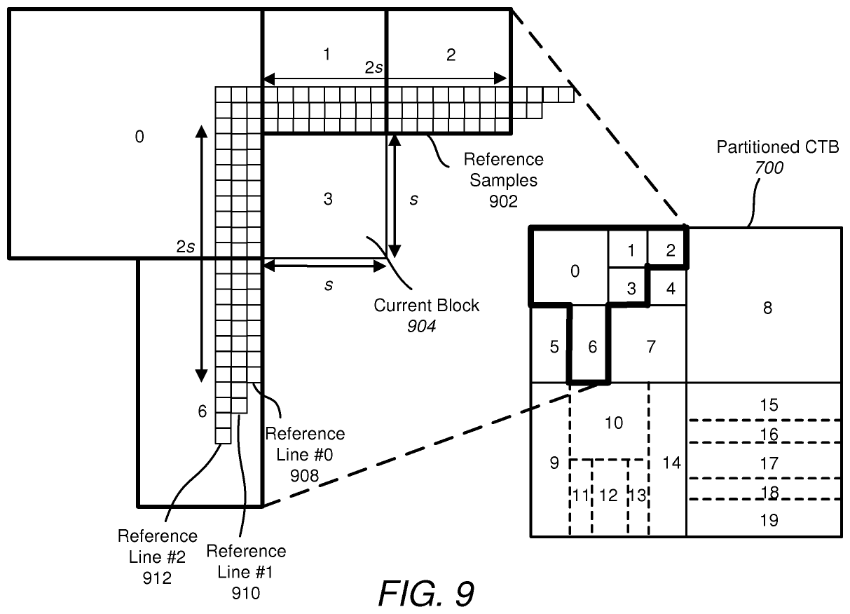

FIG. 9 shows an example set of reference samples 902 determined for intra prediction of a current block 904. Current block 904 may correspond to a block being encoded and/or decoded. Current block 904 may correspond to block 3 of partitioned CTB 700 as shown in FIG. 7. As described herein, the numeric labels 0-19 of the blocks of partitioned CTB 700 may correspond to the sequence order for encoding/decoding the blocks and may be used as such in the example of FIG. 9.

In some embodiments, reference samples 902 may include a line of samples (e.g., reference line #0 908) immediately adjacent to current block 904 and include samples from a column and a row immediately adjacent to current block 904. For example, the line of samples may include reference samples to the left and/or above current block 904. In some embodiments, reference samples 902 may be obtained (or selected) from a reference line of multiple reference lines (MRL), which may include samples adjacent to current block 904 and also non-adjacent samples. The MRL may include reference lines (e.g., reference lines 908-912) identified by corresponding reference line indices (e.g., also referred to as reference line numbers and may be identified by a variable/parameter rl_num) that indicate an i-th line of samples (e.g., i being rl_num+1) adjacent to current block 904 such that an rl_num of 0 indicates the reference line immediately adjacent (or closest) to current block 904 (i.e., a 1^{st} line of samples) and a higher value of rl_num indicates a line of samples further away from current block 904. In other words, the reference line index (which may be equivalently referred to as reference line number) may indicate a specific reference line with a unique abscissa and/or ordinate with respect to current block 904 (e.g., from a top left sample of current block 904). For example, reference samples 902 for predicting current block 904 may be retrieved or determined from reference line #0 908 (i.e., rl_num=0), reference line #1 910 (i.e., rl_num=1), or reference line #2 912 (i.e., rl_num=2). An encoder may select a reference line from a set of MRL (for example, including reference lines 908-912) and signal an MRL index (MRL_INDEX) in the bitstream to indicate the selected reference line. For example, the encoder may signal a codeword encoding the MRL index. The decoder may decode the codeword to determine the MRL index that identifies a specific reference line used in intra prediction of current block 904.

The set of MRL may be from an MRL list storing reference line indices (e.g., ref_num) indicating/identifying the corresponding reference lines. In some examples, the MRL list may include non-adjacent reference lines such as reference lines 1, 3, 5, 7, 10, and/or 12. In this example, the MRL list may be an ordered list of reference line indices such as {0, 1, 3, 5, 7, 12}, where the index 0 of the MRL list points (i.e., MRL_INDEX=0) to reference line 0 (i.e., rl_num=0), index 1 of the MRL list (i.e., MRL_INDEX=1) points to reference line 1 (i.e., rl_num=1), index 2 of the MRL list (i.e., MRL_INDEX=2) points to reference line 3 (i.e., rl_num=3), index 3 of the MRL list (i.e., MRL_INDEX=3) points to reference line 5 (i.e., rl_num=5), index 4 of the MRL list (i.e., MRL_INDEX=4) points to reference line 7 (i.e., rl_num=7), and index 5 of the MRL list (i.e., MRL_INDEX=5) points to reference line 12 (i.e., rl_num=12).

In some embodiments, the MRL list may be a preconfigured list of reference line indices. For example, the same MRL list may be predetermined and stored at both the encoder and the decoder such that the MRL list does not need to be signaled from the encoder to the decoder. In some embodiments, the MRL list may include a set of reference line indices selected at the encoder and the MRL list may be signaled in the bitstream to the decoder. For example, the MRL list may be signaled per CTU, per picture frame, per sequence of picture frame, or per video, etc.

In some embodiments, the encoder may signal a specific reference line (e.g., indicated by a reference line number/index) by signaling in the bitstream an index of the MRL list (e.g., MRL_INDEX), which may be identically determined at the decoder. The decoder may decode the MRL index to select a reference line index from the MRL list and use the reference line identified by the reference line index for intra prediction of current block 904.

For current block 904 that is w×h samples in size, reference samples 902 may comprise: 2 w samples (or any other quantity of samples) of an i-th row (e.g., indicated by an MRL index) adjacent to the top-most row of current block 904, 2 h samples (or any other quantity of samples) of the i-th column adjacent to the left-most column of current block 904, and the top left neighboring corner sample(s) extending from the i-th column and i-th row with respect to current block 904. Current block 904 may be square, such that w=h=s. In other examples, a current block need not be square, such that w≠h. Available samples from neighboring blocks of current block 904 may be used for constructing the set of reference samples 902. Samples may not be available for constructing the set of reference samples 902, for example, if the samples lie outside the picture of the current block, the samples are part of a different slice of the current block (e.g., if the concept of slices is used), and/or the samples belong to blocks that have been inter coded and constrained intra prediction is indicated. Intra prediction may not be dependent on inter predicted blocks, for example, if constrained intra prediction is indicated.

Samples that may not be available for constructing the set of reference samples 902 may comprise samples in blocks that have not already been encoded and reconstructed at an encoder and/or decoded at a decoder based on the sequence order for encoding/decoding. Restriction of such samples from inclusion in the set of reference samples 902 may allow identical prediction results to be determined at both the encoder and decoder. In the example of FIG. 9, samples from neighboring blocks 0, 1, 2, and 8 may be available to construct reference samples 902 given that these blocks are encoded and reconstructed at an encoder and decoded at a decoder prior to coding of current block 904. The samples from neighboring blocks 0, 1, 2, and 8 may be available to construct reference samples 902, for example, if there are no other issues (e.g., as mentioned above) preventing the availability of the samples from the neighboring blocks 0, 1, 2, and 8. The portion of reference samples 902 from neighboring block 6 may not be available due to the sequence order for encoding/decoding (e.g., because the block 6 may not have already been encoded and reconstructed at the encoder and/or decoded at the decoder based on the sequence order for encoding/decoding).

In some examples, unavailable samples from reference samples 902 may be filled with one or more of the available reference samples 902. For example, an unavailable reference sample may be filled with a nearest available reference sample. The nearest available reference sample may be determined by moving in a clock-wise direction through reference samples 902 from the position of the unavailable reference. The reference samples 902 may be filled with the mid-value of the dynamic range of the picture being coded, for example, if no reference samples are available.

Reference samples 902 may be filtered based on the size of current block 904 being coded and an applied intra prediction mode. FIG. 9 shows an example determination of reference samples from an associated reference line for intra prediction of a block.

Samples of current block 904 may be intra predicted based on reference samples 902, for example, based on (e.g., after) determination and (optionally) filtering of reference samples 902. At least some (e.g., most) encoders/decoders may support a plurality of intra prediction modes in accordance with one or more video coding standards. For example, HEVC supports 35 intra prediction modes, including a planar mode, a direct current (DC) mode, and 33 angular modes. VVC supports 67 intra prediction modes, including a planar mode, a DC mode, and 65 angular modes. Planar and DC modes may be used to predict smooth and gradually changing regions of a picture. Angular modes may be used to predict directional structures in regions of a picture. Any quantity of intra prediction modes may be supported.

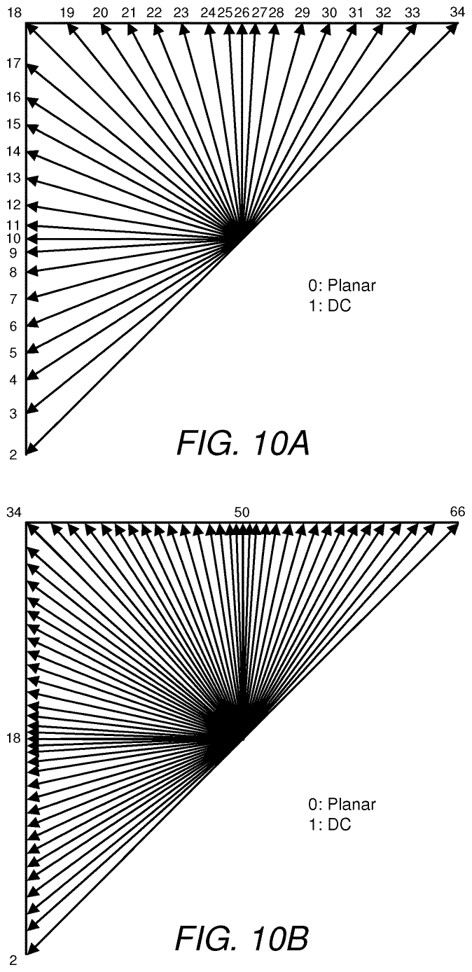

FIGS. 10A and 10B show example intra prediction modes. FIG. 10A shows 35 intra prediction modes, such as supported by HEVC. The 35 intra prediction modes may be indicated/identified by indices 0 to 34. Prediction mode 0 may correspond to planar mode. Prediction mode 1 may correspond to DC mode. Prediction modes 2-34 may correspond to angular modes. Prediction modes 2-18 may be referred to as horizontal prediction modes because the principal source of prediction is in the horizontal direction. Prediction modes 19-34 may be referred to as vertical prediction modes because the principal source of prediction is in the vertical direction.

FIG. 10B shows 67 intra prediction modes, such as supported by VVC. The 67 intra prediction modes may be indicated/identified by indices 0 to 66. Prediction mode 0 may correspond to planar mode. Prediction mode 1 corresponds to DC mode. Prediction modes 2-66 may correspond to angular modes. Prediction modes 2-34 may be referred to as horizontal prediction modes because the principal source of prediction is in the horizontal direction. Prediction modes 35-66 may be referred to as vertical prediction modes because the principal source of prediction is in the vertical direction. Some of the intra prediction modes illustrated in FIG. 10B may be adaptively replaced by wide-angle directions because blocks in VVC need not be squares.

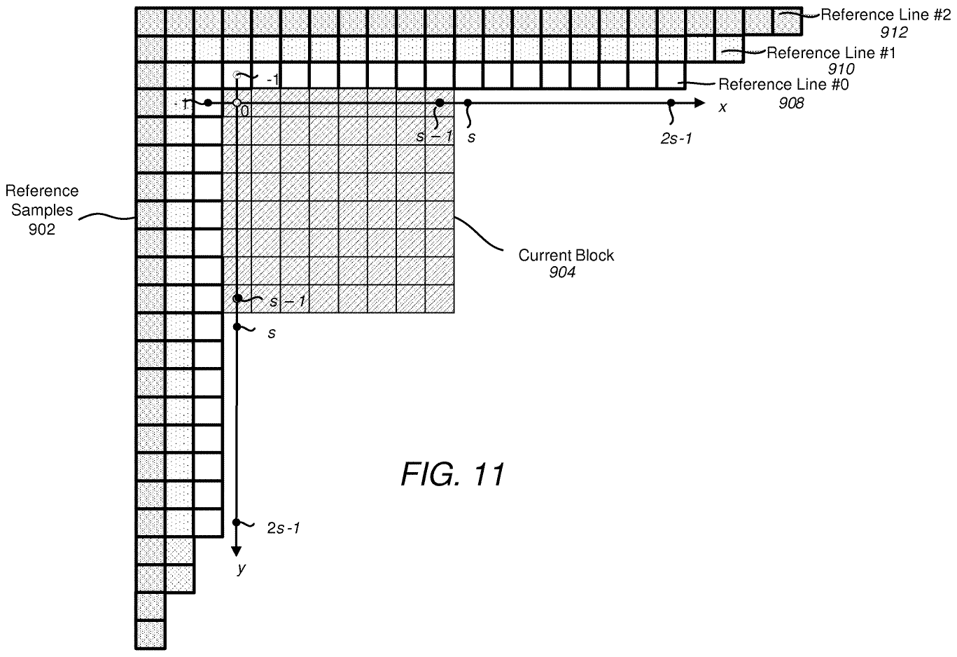

FIG. 11 shows a current block 904 and corresponding reference samples 902 from FIG. 9. To further describe how intra prediction modes are applied to determine a prediction (e.g., a prediction block) of current block 904, FIG. 11 shows current block 904 and reference samples 902, from a reference line among a set of multiple reference lines (MRL) 908-912, in a two-dimensional x, y plane, where a sample may be referenced as p[x][y]. To simplify the prediction process, reference samples 902 may be placed in two, one-dimensional arrays. The reference samples 902 belonging to a reference line l from the set of MRL 908-912, above the current block 904, may be placed in the one-dimensional array ref₁[x]:

ref₁[x]=p[−l+x][−l],(x≥0). (1)

The reference samples 902 belonging to reference line l, to the left of current block 904, may be placed in the one-dimensional array ref₂[y]:

ref₂[y]=p[−l][−l+y],(y≥0). (2)

The variable l represents how many lines away the selected reference line is from current block. For example, if reference line #0 908 is selected, then l is set to 1 to indicate the reference line adjacent to current block 904. For example, if reference line #1 910 is selected, then/is set to 2. For example, if reference line #2 912 is selected, then l is set to 3.

The prediction process may comprise determination of a predicted sample p[x][y] (e.g., a predicted value) at a location [x][y] in current block 904. For planar mode, a sample at the location [x][y] in current block 904 may be predicted by determining/calculating the mean of two interpolated values. The first of the two interpolated values may be based on a horizontal linear interpolation at the location [x][y] in current block 904. The second of the two interpolated values may be based on a vertical linear interpolation at location [x][y] in current block 904. The predicted sample p[x][y] in current block 904 may be determined/calculated as:

$$p [ x ] [ y ] = \frac{1}{2 \cdot s} ( h [ x ] [ y ] + v [ x ] [ y ] + s ) , \qquad ( 3 )$$

where

h[x][y]=(s−x−1)·ref₂[y]+(x+1)·ref₁[s] (4)

may be the horizontal linear interpolation at the location [x][y] in current block 904 and

v[x][y]=(s−y−1)·ref₁[x]+(y+1)·ref₂[s] (5)

may be the vertical linear interpolation at the location [x][y] in current block 904. s may be equal to a length of a side (e.g., a number of samples on a side) of the current block 904.

For DC mode, a sample at a location [x][y] in current block 904 may be predicted by the mean of the reference samples 902. The predicted sample p[x][y] in current block 904 may be determined/calculated as:

$$p [ x ] [ y ] = \frac{1}{2 \cdot s} ( {\sum }_{x = 0}^{s - 1} {ref}_{1} [ x ] + {\sum }_{y = 0}^{s - 1} {ref}_{2} [ y ] ) . \qquad ( 6 )$$

For angular modes, a sample at a location [x][y] in current block 904 may be predicted by projecting the location [x][y] in a direction specified by a given angular mode to a point on the horizontal or vertical line of samples comprising reference samples 902. The sample at the location [x][y] may be predicted by interpolating between the two closest reference samples of the projection point if the projection does not fall directly on a reference sample. The direction specified by the angular mode may be given by an angle φ defined relative to the y-axis for vertical prediction modes (e.g., modes 19-34 in HEVC and modes 35-66 in VVC). The direction specified by the angular mode may be given by an angle φ defined relative to the x-axis for horizontal prediction modes (e.g., modes 2-18 in HEVC and modes 2-34 in VVC).

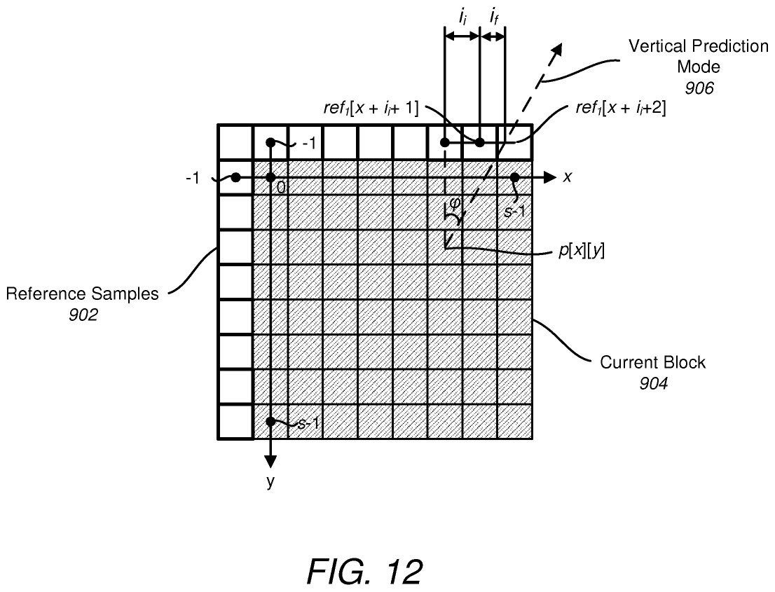

FIG. 12 shows an example applying an intra prediction mode (e.g., an angular mode such as vertical prediction mode 906) for prediction of a current block 904. FIG. 12 specifically shows prediction of a sample at a location [x][y] in current block 904 for a vertical prediction mode 906. Vertical prediction mode 906 may be given by an angle φ with respect to the vertical axis. The location [x][y] in current block 904, in vertical prediction modes, may be projected to a point (e.g., referred to as a projection point) on the horizontal line of reference samples ref₁[x]. The reference samples 902 are only partially shown in FIG. 12 for ease of illustration. As shown in FIG. 12, the projection point on the horizontal line of reference samples ref₁[x] may not be exactly on a reference sample. A predicted sample p[x][y] in current block 904 may be determined/calculated by linearly interpolating between the two reference samples, for example, if the projection point falls at a fractional sample position between two reference samples. The predicted sample p[x][y] may be determined/calculated as:

p[x][y]=(1−i_{f})·ref₁[x+iᵢ+1]+i_{f}·ref₁[x+iᵢ+2]. (7)

iᵢ may be the integer part of the horizontal displacement of the projection point relative to the location [x][y]. iᵢ may be determined/calculated as a function of the tangent of the angle φ of the vertical prediction mode 906 as:

iᵢ=└(y+1)·tan φ┘. (8)

i_{f} may be the fractional part of the horizontal displacement of the projection point relative to the location [x][y] and may be determined/calculated as:

i_{f}=((y+1)·tan φ)−└(y+1)·tan φ┘, (9)

where └·┘ is the integer floor function.

For horizontal prediction modes, a location [x][y] of a sample in current block 904 may be projected onto the vertical line of reference samples ref₂[y]. A predicted sample p[x][y] for horizontal prediction modes may be determined/calculated as:

p[x][y]=(1−i_{f})·ref₂[y+iᵢ+1]+i_{f}·ref₂[y+iᵢ+2]. (10)

iᵢ may be the integer part of the vertical displacement of the projection point relative to the location [x][y]. i may be determined/calculated as a function of the tangent of the angle φ of the horizontal prediction mode as:

iᵢ=└(x+1)·tan φ┘. (11)

if may be the fractional part of the vertical displacement of the projection point relative to the location [x][y]. i_{f} may be determined/calculated as:

i_{f}=((x+1)·tan φ)−└x+1)·tan φ┘, (12)

where └·┘ is the integer floor function.

The interpolation functions given by Equations (7) and (10) may be implemented by an encoder and/or a decoder (e.g., encoder 200 in FIG. 2 and/or decoder 300 in FIG. 3). The interpolation functions may be implemented by finite impulse response (FIR) filters. For example, the interpolation functions may be implemented as a set of two-tap FIR filters. The coefficients of the two-tap FIR filters may be respectively given by (1−i_{f}) and i_{f}. The predicted sample p[x][y], in angular intra prediction, may be calculated with some predefined level of sample accuracy (e.g., 1/32 sample accuracy, or accuracy defined by any other metric). For 1/32 sample accuracy, the set of two-tap FIR interpolation filters may comprise up to 32 different two-tap FIR interpolation filters—one for each of the 32 possible values of the fractional part of the projected displacement i_{f}. In other examples, different levels of sample accuracy may be used.

In some examples, the FIR filters may be used for predicting chroma samples and/or luma samples. For example, the two-tap interpolation FIR filter may be used for predicting chroma samples and a same and/or a different interpolation technique/filter may be used for luma samples. For example, a four-tap FIR filter may be used to determine a predicted value of a luma sample. Coefficients of the four tap FIR filter may be determined based on i_{f} (e.g., similar to the two-tap FIR filter). For 1/32 sample accuracy, a set of 32 different four-tap FIR filters may comprise up to 32 different four-tap FIR filters—one for each of the 32 possible values of the fractional part of the projected displacement i_{f}. In other examples, different levels of sample accuracy may be used. The set of four-tap FIR filters may be stored in a look-up table (LUT) and referenced based on i_{f}. A predicted sample p[x][y], for vertical prediction modes, may be determined based on the four-tap FIR filter as:

$$p [ x ] [ y ] = {\sum }_{i = 0}^{3} f T [ i ] \cdot {ref}_{1} [ x + iIdx + i ] , \qquad ( 13 )$$

where fT[i], i=0 . . . 3, may be the filter coefficients, and Idx is integer displacement. A predicted sample p[x][y], for horizontal prediction modes, may be determined based on the four-tap FIR filter as:

$$p [ x ] [ y ] = {\sum }_{i = 0}^{3} f T [ i ] \cdot {ref}_{2} [ y + iIdx + i ] . \qquad ( 14 )$$

Supplementary reference samples may be determined/constructed if the location [x][y] of a sample in current block 904 to be predicted is projected to a negative x coordinate. The location [x][y] of a sample may be projected to a negative x coordinate, for example, if negative vertical prediction angles φ are used. The supplementary reference samples may be determined/constructed by projecting the reference samples in ref₂[y] in the vertical line of reference samples 902 to the horizontal line of reference samples 902 using the negative vertical prediction angle φ. Supplementary reference samples may be similarly determined/constructed, for example, if the location [x][y] of a sample in current block 904 to be predicted is projected to a negative y coordinate. The location [x][y] of a sample may be projected to a negative y coordinate, for example, if negative horizontal prediction angles φ are used. The supplementary reference samples may be determined/constructed by projecting the reference samples in ref₁[x] on the horizontal line of reference samples 902 to the vertical line of reference samples 902 using the negative horizontal prediction angle φ.

An encoder may determine/predict samples of a current block being encoded (e.g., current block 904) for a plurality of intra prediction modes (e.g., using one or more of the functions described herein). For example, an encoder may determine/predict samples of a current block for each of 35 intra prediction modes in HEVC and/or 67 intra prediction modes in VVC. The encoder may determine, for each intra prediction mode applied, a corresponding prediction error for the current block based on a difference (e.g., sum of squared differences (SSD), sum of absolute differences (SAD), or sum of absolute transformed differences (SATD) between the prediction samples, generated from reference samples 902 of a reference line from a set of MRL, determined for the intra prediction mode and the original samples of the current block. The encoder may determine/select one of the intra prediction modes to encode the current block based on the determined prediction errors. For example, the encoder may determine/select one of the intra prediction modes that results in the smallest prediction error for the current block. In some examples, the encoder may determine/select the intra prediction mode and the associated reference line to encode the current block based on a rate-distortion measure (e.g., Lagrangian rate-distortion cost) determined using the prediction errors. The encoder may signal, in the bitstream to a decoder for decoding of the current block, an indication of the determined/selected intra prediction mode and an indication of the associated MRL index (which may indicate a reference line index). The encoder may also signal in the bitstream to the decoder a corresponding prediction error (e.g., residual) of the intra prediction mode.

A decoder may determine/predict samples of a current block being decoded (e.g., current block 904) for an intra prediction mode. For example, a decoder may receive an indication of a reference line (e.g., a reference line index or an MRL index associated with the reference line index) and an intra prediction mode (e.g., an angular intra prediction mode) from an encoder for a current block. The decoder may retrieve a set of reference samples and perform intra prediction based on the MRL index and the intra prediction mode indicated by the encoder for the current block in a similar manner (e.g., as described above for the encoder). For example, the decoder may obtain the reference samples from a reference line indicated/identified by the decoded MRL index. The decoder may add predicted values of the samples (e.g., determined based on the intra prediction mode) of the current block to a residual of the current block to reconstruct the current block. In some examples, a decoder need not receive an indication of an angular intra prediction mode from an encoder for a current block. Instead, the decoder may determine an intra prediction mode through other decoder-side means (e.g., by applying template-based intra mode derivation (TIMD) tool/technique).

While various examples herein correspond to intra prediction modes in HEVC and VVC, the methods, devices, and systems as described herein may be applied to/used for other intra prediction modes (e.g., as used in other video coding standards/formats, such as VP8, VP9, AV1, etc.).

Intra prediction may exploit correlations between spatially neighboring samples in the same picture of a video sequence to perform video compression. Inter prediction is another coding tool that may be used to perform video compression. Inter prediction may exploit correlations in the time domain between blocks of samples in different pictures of a video sequence. For example, an object may be seen across multiple pictures of a video sequence. The object may move (e.g., by some translation and/or affine motion) or remain stationary across the multiple pictures. A current block of samples in a current picture being encoded may have/be associated with a corresponding block of samples in a previously decoded picture. The corresponding block of samples may accurately predict the current block of samples. The corresponding block of samples may be displaced from the current block of samples, for example, due to movement of the object, represented in both blocks, across the respective pictures of the blocks. The previously decoded picture may be a reference picture. The corresponding block of samples in the reference picture may be a reference block for motion compensated prediction. An encoder may use a block matching technique to estimate the displacement (or motion) of the object and/or to determine the reference block in the reference picture.

Similar to intra prediction, an encoder may determine a difference between a current block and a prediction for a current block. An encoder may determine a difference, for example, based on/after determining/generating a prediction for a current block (e.g., using inter prediction). The difference may be a prediction error (e.g., a residual). The encoder may store and/or send (e.g., signal), in/via a bitstream, the prediction error and/or other related prediction information. The prediction error and/or other related prediction information may be used for decoding and/or other forms of consumption. A decoder may decode the current block by predicting the samples of the current block (e.g., by using the related prediction information) and combining the predicted samples with the prediction error.

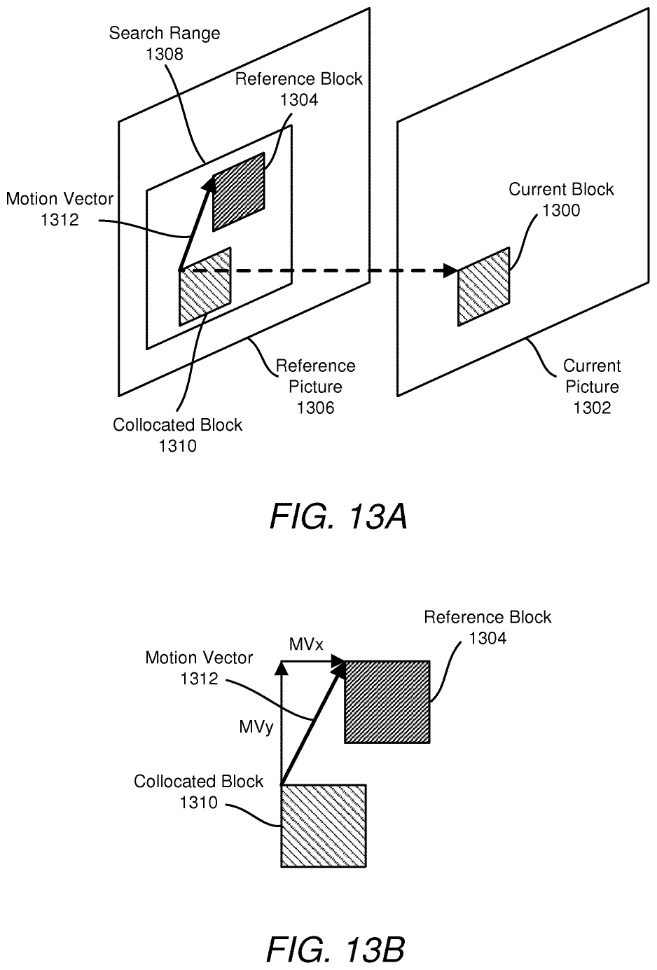

FIG. 13A shows an example of inter prediction. The inter prediction may be performed for a current block 1300 in a current picture 1302 being encoded. An encoder (e.g., encoder 200 as shown in FIG. 2) may perform inter prediction to determine and/or generate a reference block 1304 in a reference picture 1306. Reference block 1304 may be used to predict the current block 1300. Reference pictures (e.g., reference picture 1306) may be prior decoded pictures available at the encoder and/or a decoder. Availability of a prior decoded picture may depend/be based on whether the prior decoded picture is available in a decoded picture buffer, at the time, current block 1300 is being encoded and/or decoded. The encoder may search the one or more reference pictures 1306 for a block (e.g., a candidate reference block) that is similar (or substantially similar) to current block 1300. The encoder may determine the best matching block from the blocks (e.g., candidate reference blocks) tested during the searching process. The best matching block may be a reference block 1304. The encoder may determine that reference block 1304 is the best matching reference block based on one or more cost criteria. The one or more cost criteria may comprise a rate-distortion criterion (e.g., Lagrangian rate-distortion cost). The one or more cost criteria may be based on a difference (e.g., SSD, SAD, and/or SATD) between prediction samples of reference block 1304 and original samples of current block 1300.

The encoder may search for reference block 1304 within a reference region (e.g., a search range 1308). The reference region (e.g., a search range 1308) may be positioned around a collocated block (or position) 1310, of current block 1300, in reference picture 1306. Collocated block 1310 may have a same position in the reference picture 1306 as the current block 1300 in the current picture 1302. The reference region (e.g., search range 1308) may at least partially extend outside of reference picture 1306. Constant boundary extension may be used, for example, if the reference region (e.g., search range 1308) extends outside of reference picture 1306. The constant boundary extension may be used such that values of the samples in a row or a column of reference picture 1306, immediately adjacent to a portion of the reference region (e.g., search range 1308) extending outside of reference picture 1306, may be used for sample locations outside of reference picture 1306. A subset of potential positions, or all potential positions, within the reference region (e.g., search range 1308) may be searched for reference block 1304. The encoder may utilize one or more search implementations to determine and/or generate the reference block 1304. For example, the encoder may determine a set of candidate search positions based on motion information of neighboring blocks (e.g., a motion vector 1312) to the current block 1300.

One or more reference pictures may be searched by the encoder during inter prediction to determine and/or generate the best matching reference block. The reference pictures searched by the encoder may be included in (e.g., added to) one or more reference picture lists. For example, in HEVC and VVC (and/or in one or more other communication protocols), two reference picture lists may be used (e.g., a reference picture list 0 and a reference picture list 1). A reference picture list may include one or more pictures. The reference picture 1306 of reference block 1304 may be indicated by a reference index pointing into a reference picture list comprising reference picture 1306.

FIG. 13B shows an example motion vector. A displacement between reference block 1304 and current block 1300 may be interpreted as an estimate of the motion between reference block 1304 and current block 1300 across their respective pictures. The displacement may be represented by a motion vector 1312. For example, motion vector 1312 may be indicated by a horizontal component (MVx) and a vertical component (MVy) relative to the position of current block 1300. A motion vector (e.g., motion vector 1312) may have fractional or integer resolution. A motion vector with fractional resolution may point between two samples in a reference picture to provide a better estimation of the motion of current block 1300. For example, a motion vector may have ½, ¼, ⅛, 1/16, 1/32, or any other fractional sample resolution. Interpolation between the two samples at integer positions may be used to generate a reference block and its corresponding samples at fractional positions, for example, if a motion vector points to a non-integer sample value in the reference picture. The interpolation may be performed by a filter with two or more taps.

The encoder may determine a difference (e.g., a corresponding sample-by-sample difference) between reference block 1304 and current block 1300. The encoder may determine the difference between reference block 1304 and current block 1300, for example, based on/after reference block 1304 is determined and/or generated, using inter prediction, for current block 1300. The difference may be a prediction error (e.g., a residual). The encoder may store and/or send (e.g., signal), in/via a bitstream, the prediction error and/or related motion information. The prediction error and/or the related motion information may be used for decoding (e.g., decoding current block 1300) and/or other forms of consumption. The motion information may comprise the motion vector 1312 and a reference indicator/index. The reference indicator may indicate the reference picture 1306 in a reference picture list. In other examples, the motion information may comprise an indication of motion vector 1312 and/or an indication of the reference indicator/index. The reference indicator may indicate reference picture 1306 in the reference picture list comprising reference picture 1306. A decoder may decode current block 1300 by determining and/or generating the reference block 1304, which may correspond to/form (e.g., be considered as) a prediction of the current block 1300. The decoder may determine and/or generate the reference block 1304, for example, based on the related motion information. The decoder may decode current block 1300 based on combining the prediction (e.g., a reference block) with the prediction error (e.g., a residual block).

Inter prediction, as shown in FIG. 13A, may be performed using one reference picture 1306 as a source of a prediction for current block 1300. Inter prediction based on a prediction of a current block using a single picture may be referred to as uni-prediction.

Inter prediction of a current block, using bi-prediction, may be based on two pictures (e.g., the source of prediction may be from the two pictures). Bi-prediction may be useful, for example, if a video sequence comprises fast motion, camera panning, zooming, and/or scene changes. Bi-prediction also may be useful to capture fade outs of one scene or fade outs from one scene to another, where two pictures may effectively be displayed simultaneously with different levels of intensity.

One or both of uni-prediction and bi-prediction may be available/used for performing inter prediction (e.g., at an encoder and/or at a decoder). Performing a specific type of inter prediction (e.g., uni-prediction and/or bi-prediction) may depend on a slice type of current block. For example, for P slices, only uni-prediction may be available/used for performing inter prediction. For B slices, either uni-prediction or bi-prediction may be available/used for performing inter prediction. An encoder may determine and/or generate a reference block, for predicting a current block, from a reference picture list 0, for example, if the encoder is using uni-prediction. An encoder may determine and/or generate a first reference block, for predicting a current block, from a reference picture list 0 and determine and/or generate a second reference block, for predicting the current block, from a reference picture list 1, for example, if the encoder is using bi-prediction.

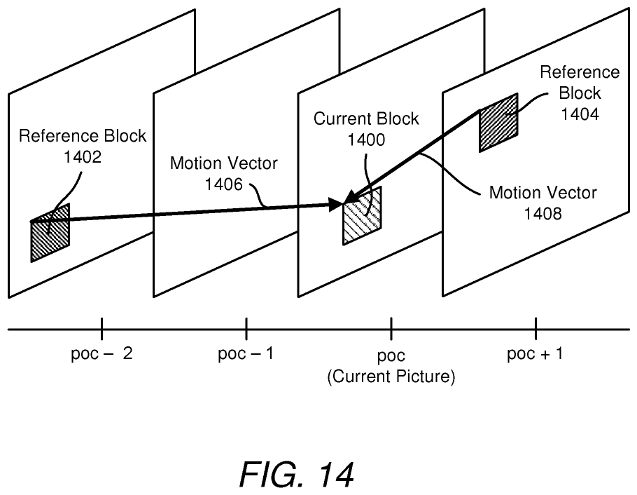

FIG. 14 shows an example of bi-prediction. Two reference blocks 1402 and 1404 may be used to predict a current block 1400. Reference block 1402 may be in a reference picture of one of reference picture list 0 or reference picture list 1. Reference block 1404 may be in a reference picture of another one of reference picture list 0 or reference picture list 1. As shown in FIG. 14, reference block 1402 may be in a first picture that precedes (e.g., in time) a current picture of current block 1400, and the reference block 1404 may be in a second picture that succeeds (e.g., in time) the current picture of current block 1400. The first picture may precede the current picture in terms of a picture order count (POC). The second picture may succeed the current picture in terms of the POC. In other examples, the reference pictures may both precede or both succeed the current picture in terms of POC. A POC may be/indicate an order in which pictures are output (e.g., from a decoded picture buffer). A POC may be/indicate an order in which pictures are generally intended to be displayed. Pictures that are output may not necessarily be displayed but may undergo different processing and/or consumption (e.g., transcoding). The two reference blocks determined and/or generated using/for bi-prediction may correspond to (e.g., be comprised in) a same reference picture. The reference picture may be included in both the reference picture list 0 and the reference picture list 1, for example, if the two reference blocks correspond to the same reference picture.

A configurable weight and/or offset value may be applied to one or more inter prediction reference blocks. An encoder may enable the use of weighted prediction using a flag in a picture parameter set (PPS). The encoder may send/signal the weight and/or offset parameters in a slice segment header for current block 1400. Different weight and/or offset parameters may be sent/signaled for luma and/or chroma components.

The encoder may determine and/or generate the reference blocks 1402 and 1404 for the current block 1400 using inter prediction. The encoder may determine a difference between current block 1400 and each of reference blocks 1402 and 1404. The differences may be prediction errors or residuals. The encoder may store and/or send/signal, in/via a bitstream, the prediction errors and/or their respective related motion information. The prediction errors and their respective related motion information may be used for decoding and/or other forms of consumption.

The motion information for reference block 1402 may comprise a motion vector 1406 and/or a reference indicator/index. The reference indicator may indicate a reference picture, of the reference block 1402, in a reference picture list. In some examples, the motion information for reference block 1402 may comprise an indication of motion vector 1406 and/or an indication of the reference index. The reference index may indicate the reference picture, of reference block 1402, in the reference picture list.

The motion information for reference block 1404 may comprise a motion vector 1408 and/or a reference index/indicator. The reference indicator may indicate a reference picture, of the reference block 1404, in a reference picture list. The motion information for reference block 1404 may comprise an indication of motion vector 1408 and/or an indication of the reference index. The reference index may indicate the reference picture, of the reference block 1404, in the reference picture list.

A decoder may decode current block 1400 by determining and/or generating the reference blocks 1402 and 1404. The decoder may determine and/or generate the reference blocks 1402 and 1404, for example, based on the respective related motion information for the reference blocks 1402 and 1404. The reference blocks 1402 and 1404 may correspond to/form (e.g., be considered as) the prediction (e.g., used to generate a prediction block) of the current block 1400. The decoder may decode the current block 1400 based on combining the prediction with the prediction errors.

Motion information may be predictively coded, for example, before being stored and/or sent/signaled in/via a bit stream (e.g., in HEVC, VVC, and/or other video coding standards/formats/protocols). The motion information for a current block may be predictively coded based on motion information of one or more blocks neighboring the current block. The motion information of the neighboring block(s) may often correlate with the motion information of the current block because the motion of an object represented in the current block is often the same as (or similar to) the motion of objects in the neighboring block(s). Motion information prediction techniques (such as those in HEVC and VVC) may comprise advanced motion vector prediction (AMVP) and/or inter prediction block merging (e.g., merge mode).

An encoder (e.g., encoder 200 as shown in FIG. 2), may code a motion vector. The encoder may code the motion vector (e.g., using AMVP) as a difference between a motion vector of a current block being coded and a motion vector predictor (MVP). An encoder may determine/select the MVP from a list of candidate MVPs. The candidate MVPs may be/correspond to previously decoded motion vectors of neighboring blocks in the current picture of the current block, and/or blocks at or near the collocated position of the current block in other reference pictures. The encoder and/or a decoder may reciprocally generate and/or determine the list of candidate MVPs.

The encoder may determine/select an MVP from the list of candidate MVPs. Then, the encoder may send/signal, in/via a bitstream, an indication of the selected MVP and/or a motion vector difference (MVD). The encoder may indicate the selected MVP in the bitstream using an index/indicator. The index may indicate the selected MVP in the list of candidate MVPs. The MVD may be determined/calculated based on a difference between the motion vector of the current block and the selected MVP. For example, for a motion vector (e.g., comprising a horizontal component (MVx) and a vertical component (MVy) that indicates a position relative to a position of the current block being coded, the MVD may be represented by two components MVDₓ and MVD_{y}. MVDₓ and MVD_{y} may be determined/calculated as:

MVDₓ=MVₓ−MVPₓ, (15)

MVD_{y}=MV_{y}−MVP_{y}. (16)

MVDx and MVDy may respectively represent horizontal and vertical components of the MVD. MVPx and MVPy may respectively represent horizontal and vertical components of the MVP.

A decoder (e.g., decoder 300 as shown in FIG. 3) may decode the motion vector by adding the MVD to the MVP indicated in/via the bitstream. The decoder may decode the current block by determining and/or generating the reference block. The decoder may determine and/or generate the reference block, for example, based on the decoded motion vector. The reference block may correspond to/form (e.g., be considered as) the prediction of the current block (e.g., a prediction block). The decoder may decode the current block by combining the prediction with the prediction error.

The list of candidate MVPs (e.g., in HEVC, VVC, and/or one or more other communication protocols), for AMVP, may comprise two or more candidates (e.g., candidates A and B). Candidates A and B may comprise: up to two (or any other quantity of) spatial candidate MVPs determined/derived from five (or any other quantity of) spatial neighboring blocks of a current block being coded; one (or any other quantity of) temporal candidate MVP determined/derived from two (or any other quantity of) temporal, co-located blocks (e.g., if both of the two spatial candidate MVPs are not available or are identical); and/or zero motion vector candidate MVPs (e.g., if one or both of the spatial candidate MVPs or temporal candidate MVPs are not available). Other quantities of spatial candidate MVPs, spatial neighboring blocks, temporal candidate MVPs, and/or temporal, co-located blocks may be used for the list of candidate MVPs.

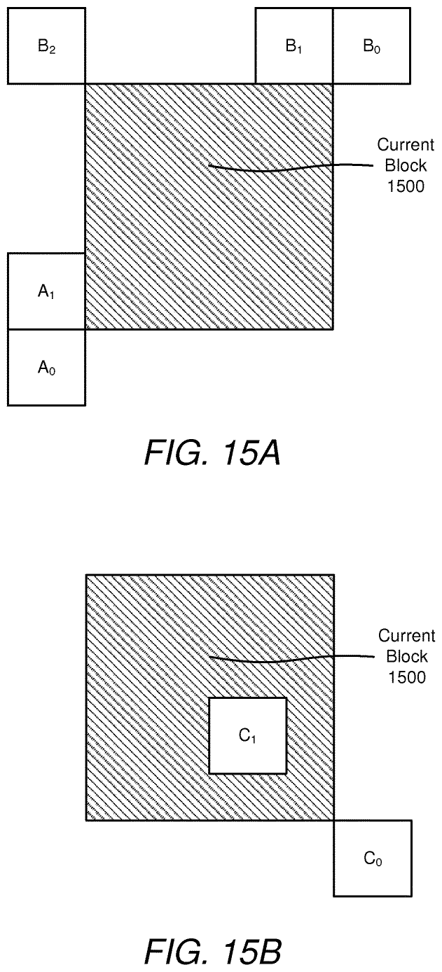

FIG. 15A shows example spatial candidate neighboring blocks for a current block. For example, five (or any other quantity of) spatial candidate neighboring blocks may be located relative to a current block 1500 being encoded. The five spatial candidate neighboring blocks may be A0, A1, B0, B1, and B2. FIG. 15B shows temporal, co-located blocks for the current block. For example, two (or any other quantity of) temporal, co-located blocks may be located relative to current block 1500 being coded. The two temporal, co-located blocks may be C0 and C1. The two temporal, co-located blocks may be in one or more reference pictures that may be different from the current picture of current block 1500.

An encoder (e.g., encoder 200 as shown in FIG. 2) may code a motion vector using inter prediction block merging (e.g., a merge mode). For example, the encoder (e.g., using merge mode) may reuse the same motion information of a neighboring block (e.g., one of neighboring blocks A0, A1, B0, B1, and B2) for inter prediction of a current block. For example, the encoder (e.g., using merge mode) may reuse the same motion information of a temporal, co-located block (e.g., one of temporal, co-located blocks C0 and C1) for inter prediction of a current block. An MVD need not be sent (e.g., indicated, signaled) for the current block because the same motion information as that of a neighboring block or a temporal, co-located block may be used for the current block (e.g., at the encoder and/or a decoder). A signaling overhead for sending/signaling the motion information of the current block may be reduced because the MVD need not be indicated for the current block. The encoder and/or the decoder may reciprocally generate a candidate list of motion information from neighboring blocks or temporal, co-located blocks of the current block (e.g., in a manner similar to AMVP). The encoder may determine to use (e.g., inherit) motion information, of one neighboring block or one temporal, co-located block in the candidate list, for predicting motion information of the current block being coded. The encoder may signal/send, in/via a bitstream, an indication of the determined motion information from the candidate list. For example, the encoder may signal/send an indicator/index. The index may indicate the determined motion information in the list of candidate motion information. The encoder may signal/send the index to indicate the determined motion information.

A list of candidate motion information for merge mode (e.g., in HEVC, VVC, or any other coding formats/standards/protocols) may comprise: up to four (or any other quantity of) spatial merge candidates derived/determined from five (or any other quantity of) spatial neighboring blocks (e.g., as shown in FIG. 15A); one (or any other quantity of) temporal merge candidate derived from two (or any other quantity of) temporal, co-located blocks (e.g., as shown in FIG. 15B); and/or additional merge candidates comprising bi-predictive candidates and zero motion vector candidates. In some examples, the spatial neighboring blocks and the temporal, co-located blocks used for merge mode may be the same as the spatial neighboring blocks and the temporal, co-located blocks used for AMVP.

Inter prediction may be performed in other ways and variants than those described herein. For example, motion information prediction techniques other than AMVP and merge mode may be used. While various examples herein correspond to inter prediction modes, such as used in HEVC and VVC, the methods, devices, and systems as described herein may be applied to/used for other inter prediction modes (e.g., as used for other video coding standards/formats such as VP8, VP9, AV1, etc.). History based motion vector prediction (HMVP), combined intra/inter prediction mode (CIIP), and/or merge mode with motion vector difference (MMVD) (e.g., as described in VVC) may be performed/used and are within the scope of the present disclosure.

A block matching operation (or technique) may be applied/used (e.g., in inter prediction) to determine a reference block in a different picture than that of a current block being coded (e.g., encoded and/or decoded). A block matching operation also may be applied/used to determine a reference block in a same picture as that of a current block being coded. The reference block, in a same picture as that of the current block, as determined using block matching may often not accurately predict the current block (e.g., for camera captured videos). Prediction accuracy for screen content videos may not be similarly impacted, for example, if a reference block in the same picture as that of the current block is used for encoding. Screen content videos may comprise, for example, computer generated text, graphics, animation, etc. Screen content videos may comprise (e.g., may often comprise) repeated patterns (e.g., repeated patterns of text and/or graphics) within the same picture. Using a reference block (e.g., as determined using block matching), in a same picture as that of a current block being encoded, may provide efficient compression for screen content videos.

A prediction technique may be used (e.g., in HEVC, VVC, and/or any other coding standards/formats/protocols) to exploit correlation between blocks of samples within a same picture (e.g., of screen content videos). The prediction technique may be intra block copy (IBC) or current picture referencing (CPR). An encoder may apply/use a block matching technique (e.g., similar to inter prediction) to determine a displacement vector (e.g., a block vector (BV). The BV may indicate a relative position of a reference block (e.g., in accordance with intra block compensated prediction), that best matches the current block, from a position of the current block. For example, the relative position of the reference block may be a relative position of a top-left corner (or any other point/sample) of the reference block. The BV may indicate a relative displacement from the current block to the reference block that best matches the current block. The encoder may determine the best matching reference block from blocks tested during a searching process (e.g., in a manner similar to that used for inter prediction). The encoder may determine that a reference block is the best matching reference block based on one or more cost criteria. The one or more cost criteria may comprise a rate-distortion criterion (e.g., Lagrangian rate-distortion cost). The one or more cost criteria may be based on, for example, one or more differences (e.g., an SSD, an SAD, an SATD, and/or a difference determined based on a hash function) between the prediction samples of the reference block and the original samples of the current block. A reference block may correspond to/comprise prior decoded blocks of samples (e.g., reconstructed samples) of the current picture. The reference block may comprise decoded blocks of samples of the current picture prior to being processed by in-loop filtering operations (e.g., deblocking and/or SAO filtering).

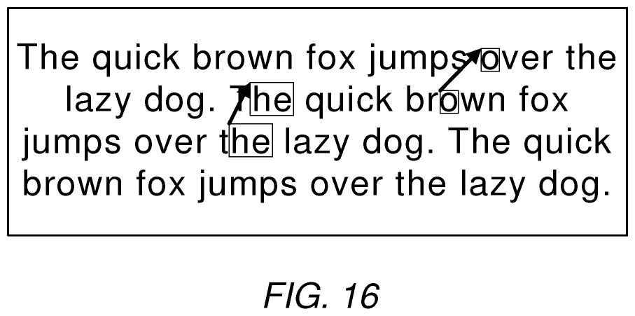

FIG. 16 shows an example of IBC (e.g., an IBC mode). The example shown in FIG. 16 may correspond to screen content. The rectangular portions/sections with arrows beginning at their boundaries may be the current blocks being encoded. The rectangular portions/sections that the arrows point to may be the reference blocks for predicting the respective current blocks.

A reference block may be determined and/or generated, for a current block, using IBC. The encoder may determine a difference (e.g., a corresponding sample-by-sample difference) between the reference block and the current block. The difference may be a prediction error or residual. The encoder may store and/or send/signal, in/via a bitstream the prediction error and/or related prediction information. The prediction error and/or the related prediction information may be used for decoding and/or other forms of consumption. The prediction information may comprise a BV. The prediction information may comprise an indication of the BV. A decoder (e.g., decoder 300 as shown in FIG. 3), may decode the current block by determining and/or generating the reference block. The decoder may determine and/or generate the current block, for example, based on the prediction information (e.g., the BV). The reference block may correspond to/form (e.g., be considered as) the prediction (e.g., a prediction block) of the current block. The decoder may decode the current block by combining the prediction (e.g., prediction block) with the prediction error (e.g., residual or residual block).

A BV may be predictively coded (e.g., in HEVC, VVC, and/or any other coding standards/formats/protocols) before being stored and/or sent/signaled in/via a bitstream. For example, the BV for a current block may be predictively coded based on a BV of one or more blocks neighboring the current block. For example, an encoder may predictively code a BV using the merge mode (e.g., in a manner similar to as described herein for inter prediction), AMVP (e.g., as described herein for inter prediction), or a technique similar to AMVP. The technique similar to AMVP may be BV prediction and difference coding (or AMVP for IBC).

An encoder (e.g., encoder 200 as shown in FIG. 2) performing BV prediction and coding may code a BV as a difference between the BV of a current block being coded and a block vector predictor (BVP). An encoder may select/determine the BVP from a list of candidate BVPs. The candidate BVPs may comprise/correspond to previously decoded BVs of neighboring blocks in the current picture of the current block. The encoder and/or a decoder may reciprocally generate or determine the list of candidate BVPs.

The encoder may send/signal, in/via a bitstream, an indication of the selected BVP and a block vector difference (BVD). The encoder may indicate the selected BVP in the bitstream using an index/indicator. The index may indicate (e.g., point to) the selected BVP in the list of candidate BVPs. The BVD may be determined/calculated based on a difference between a BV of the current block and the selected BVP. For example, for a BV (e.g., represented by a horizontal component (BVx) and a vertical component (BVy)) that indicates a position relative to a position of the current block being coded, the BVD may be represented by two components BVDₓ and BVD_{y}. BVDₓ and BVD_{y} may be determined/calculated as:

BVDₓ=BVₓ−BVPₓ, (17)

BVD_{y}=BV_{y}−BVP_{y}. (18)

BVDx and BVDy may respectively represent horizontal and vertical components of the BVD. BVPx and BVPy may respectively represent horizontal and vertical components of the BVP. A decoder (e.g., decoder 300 as shown in FIG. 3), may decode the BV by adding the BVD to the BVP indicated in/via the bitstream. The decoder may decode the current block by determining and/or generating the reference block. The decoder may determine and/or generate the reference block, for example, based on the decoded BV. The reference block may correspond to/form (e.g., be considered as) the prediction (e.g., a prediction block) of the current block. The decoder may decode the current block by combining the prediction (e.g., the prediction block) with the prediction error (e.g., residual or residual block).

A same BV as that of a neighboring block may be used for the current block and a BVD need not be separately signaled/sent for the current block, such as in the merge mode. A BVP (in the candidate BVPs), which may correspond to a decoded BV of the neighboring block, may itself be used as a BV for the current block. Not sending the BVD may reduce the signaling overhead.

A list of candidate BVPs (e.g., in HEVC, VVC, and/or any other coding standard/format/protocol) may comprise two (or more) candidates. The candidates may comprise candidates A and B. Candidates A and B may comprise: up to two (or any other quantity of) spatial candidate BVPs determined/derived from five (or any other quantity of) spatial neighboring blocks of a current block being encoded; and/or one or more of last two (or any other quantity of) coded BVs (e.g., if spatial neighboring candidates are not available). Spatial neighboring candidates may not be available, for example, if neighboring blocks are encoded using intra prediction or inter prediction. Locations of the spatial candidate neighboring blocks, relative to a current block, being encoded using IBC may be illustrated in a manner similar to spatial candidate neighboring blocks used for coding motion vectors in inter prediction (e.g., as shown in FIG. 15A). For example, five spatial candidate neighboring blocks of a current block being coded using IBC may be respectively denoted A0, A1, B0, B1, and B2 as shown in FIG. 15A.

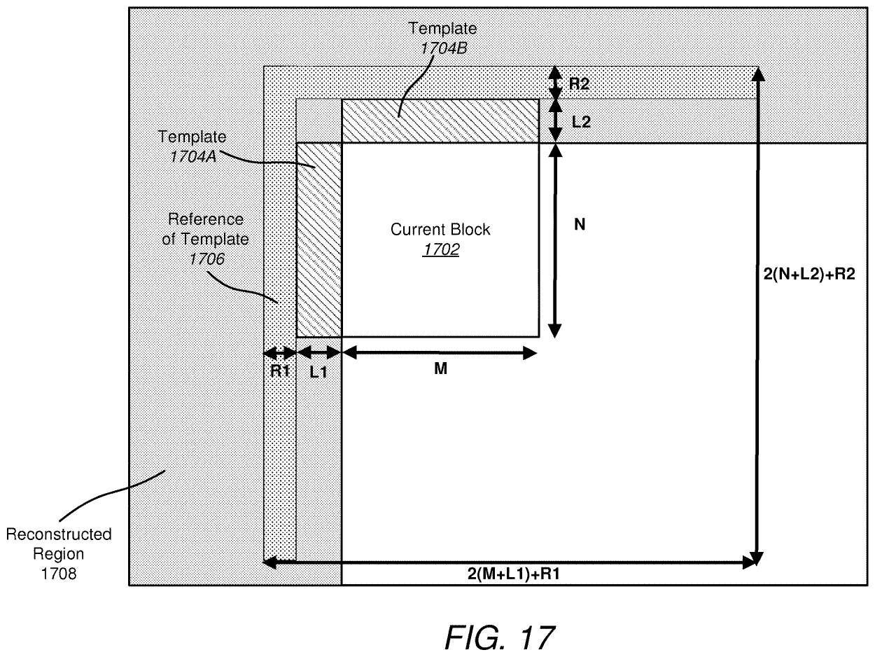

FIG. 17 shows an example of template-based intra mode derivation (TIMD) for coding a current block, according to some embodiments. TIMD is a type of intra prediction in which an intra prediction mode (IPM) may be reciprocally determined (e.g., independently derived) by an encoder (e.g., encoder 200) and a decoder (e.g., decoder 300) such that the IPM determined (e.g., selected) by the encoder does not need to be signaled to the decoder. Hence signaling bandwidth is reduced and TIMD may be considered as a type of decoder-side intra mode derivation process.

As shown in FIG. 17, for TIMD, a video coder (e.g., encoder 200 or decoder 300) may determine a template 1704 for current block 1702. Template 1704 may comprise one or more regions of samples in a reconstructed region 1708 of a current picture (or frame) of current block 1702. The one or more regions may include reconstructed samples neighboring (e.g., adjacent to) current block 1702. In some examples, the one or more regions of template 1704 may comprise a template region 1704A to the left of current block 1702 (e.g., a left template) and a template region 1704B above current block 1702 (e.g., an above template). In some examples, template 1704 may include a region that is above and to the left of current block 1702 (e.g., the region enclosed by reference of template 1706 and template regions 1704A-B). Template regions 1704A and 1704B may have a thickness (e.g., width and height respectively) of R1 and R2 samples, respectively. For example, R1 and/or R2 may be 2 samples, 4 samples, 8 samples, etc. Template region 1704A may have a height of N samples, which may be a height of current block 1702. Template region 1704B may have a width of M samples, which may be a width of current block 1702.

In TIMD, reference of template 1706 are used to derive a template predictor for template 1704. The video coder may determine (e.g., select and obtain) reference of template 1706 as a region of samples (in reconstructed region 1708) neighboring (e.g., adjacent to) template 1704. For example, reference of template 1706 may comprise reconstructed samples left and/or above template 1704. Reference of template 1706 may have a thickness to the left of template region 1704A of R1 samples and a thickness above template region 1704B of R2 samples. For example, R1 and/or R2 may be 1 sample. In some examples, similar to reference samples 902 being selected from a reference line of MRL as explained in FIG. 9, reference of template 1706 may include template reference samples selected from a template reference line of template MRL. Thus, reference of template 1706 may refer to a region of samples greater than 1 sample wide and be, e.g., 2 samples wide indicating two template reference lines, 4 samples indicating four template reference lines, etc. In some examples, reference of template 1706 may include an upper region having a width greater than template region 1704B (e.g., a width that is greater or equal to twice the width of template region 1704B, 2(M+L1) samples, 2(M+L1)+R1 samples, etc.). In some examples, reference of template 1706 may include a left region having a height greater than template region 1704A (e.g., a height that is greater or equal to twice the height of template region 1704A, 2(N+L1) samples, 2(N+L1)+R2 samples, etc.).

In some examples, a TIMD mode predictor may be determined using a list of candidate intra prediction modes (IPMs). For example, the list may include IPMs from a most probable mode (MPM) list. In some examples, one or more of a DC mode, a planar mode, a horizontal and/or vertical DC mode, or a horizontal and/or vertical planar may be added to the list of candidate IPMs. A cost (e.g., SAD or SATD) for each candidate IPM in the list may be determined based on differences between reconstructed samples in template 1704 and predicted samples of template 1704 generated based on reference of template 1706 and using the candidate IPM. For example, the video coder may determine the predicted samples by applying the candidate IPM to samples of reference of template 1706.

In some examples, a first IPM and a second IPM, from the list, with the lowest costs of costs (determined for candidate IPMs in the list) are selected to determine (e.g., derive) a first TIMD mode and a second TIMD mode. In an example, the first and second TIMD modes are determined as the first and second IPMs, respectively.

In some examples, the first and second TIMD modes may be determined by refining the first and second IPMs. For example, an angular mode range may be extended from a first range of the list (e.g., 67 modes) to a second range (e.g., 131 modes) and costs of the two adjacent modes (i.e., +/−1 mode) of each selected IPM may be determined. For example, the first TIMD mode may be determined as an IPM having the smallest cost among costs of the first IPM and its two adjacent modes in the second range. The second TIMD mode may be determined as an IPM having the smallest cost among costs of the second IPM and its two adjacent modes in the second range.

In some embodiments, based on the second TIMD mode not being selected for predicting the current block, the TIMD mode predictor may be determined as the first TIMD mode only. In some embodiments, a TIMD mode predictor may be determined based on combining (e.g., blending or fusing) the first TIMD mode and the second TIMD mode. For example, the TIMD mode predictor may be a linear combination of the first TIMD mode and the second TIMD mode.

In some embodiments, the first and second TIMD modes are determined based on reference samples from a same reference line neighboring template 1704 such as a reference line #0 (template reference line #0) that is immediately adjacent to template 1704. Similarly, template reference line #0 may correspond to template reference line index 0 and may be the closest template reference line (i.e., immediately adjacent) to template 1704.

In some embodiments, the TIMD mode predictor may be determined based on generating the first TIMD mode and the second TIMD mode. For example, the first TIMD mode may be generated by applying the first TIMD mode to reference samples from a reference line/(for instance/is reference line #0) in the neighborhood of current block 1702 and the second TIMD mode may be generated by applying the second TIMD mode to reference samples from either the same reference line (l) or another reference line (for instance l+1 where l+1 designates reference line #1) depending on a set of conditions. For example, reference line l+1 may be selected for generating the second TIMD mode based on the following being satisfied: the current block is not coded as an intra sub-partition (ISP) block, and the second TIMD mode is an angular prediction mode not represented by non-fractional angles. Otherwise, the reference line/is selected for generating the second TIMD mode. Generally, reference samples used to generate the first and second TIMD modes are located in template 1704.

In some embodiments, each weight of the generated first and second TIMD modes, in the linear combination, may be determined based on costs of the selected first and second TIMD modes, respectively. For example, a weight, for a selected TIMD mode, may be determined as being inversely proportional to a cost of the TIMD mode. The TIMD mode predictor may be applied to template 1704 (e.g., reference line #0 in template 1704) to determine a prediction block for current block 1702. An encoder may generate a residual (e.g., prediction error) based on a difference between the prediction block and current block 1702. A decoder may reconstruct current block 1702 based on the reciprocally generated prediction block and the residual received from the encoder in a bitstream.

In some embodiments, selection of the second TIMD mode (IPM₂) for the fusion process may be further based on comparing a cost (costIPM₁) of the first TIMD mode (IPM₁) against a threshold cost. In an example, the threshold cost may be a fixed value. In some examples, the threshold cost may be based on the first IPM cost. In an example, the threshold cost comprises scaling a cost of a selected TIMD mode (e.g., the first TIMD mode with the lowest cost) by a scaling factor a greater than 1. For example, the second TIMD mode (IPM₂) may be selected for blending in the fusion process if the following condition (21) is fulfilled:

costIPM₂<a·costIPM₁ (21)

where: a is greater than 1 (e.g., a may be a value in the range of 1 to 2); costIPM₂ is a cost (e.g., SATD, SSE, SAD, etc.) of the second TIMD mode; and costIPM₁ is the cost of the first TIMD mode.

In some examples, the first TIMD mode is determined as the TIMD mode predictor (i.e., the TIMD mode predictor is derived only from the first TIMD mode, without fusion process of one or more additional TIMD modes), for example, based on condition (21) not being fulfilled. In these examples, the first TIMD mode was selected using reference samples from a template reference line with template MRL index #0 (i.e., reference line #0 adjacent to the template), but the TIMD predictor may be generated by applying the first TIMD mode to a different reference line index (e.g., with respect to the example MRL list described in FIG. 9, MRL index #1 would indicate reference line #1 adjacent to the current block and MRL index #2 would indicate reference line #3 adjacent to the current block) signaled in the bitstream. For example, during an encoder side rate-distortion optimization (RDO) check, the TIMD predictor generated with the reference line/from the MRL list providing the lowest RDO cost may be selected and signaled as the MRL index (indicating the reference line/in the MRL list) associated with the selected TIMD predictor.

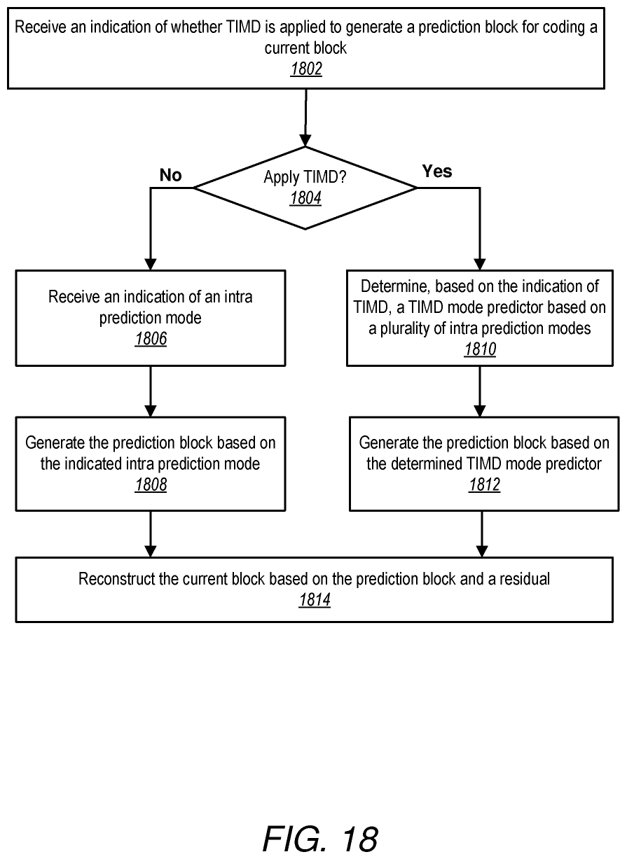

FIG. 18 shows an example of TIMD signaling for decoding a current block, according to some embodiments. At block 1802, a decoder (e.g., decoder 300 of FIG. 3) receives (e.g., from a bitstream) an indication of whether TIMD is applied to generate a prediction block for coding a current block. As explained above, TIMD is a type of intra prediction in which a template, of the current block, in the reconstructed region of the picture is used to derive an intra prediction mode for coding the current block. For example, the indication may be a flag that indicates whether TIMD is enabled (e.g., applied).

At block 1804, the decoder determines whether to apply TIMD based on the indication received at block 1802. At block 1810, based on the indication of TIMD being applied (e.g., enabled or being selected), the decoder determines (e.g., derives) a TIMD mode predictor based on a plurality of intra prediction modes (IPMs), e.g., without additional signaling from an encoder indicating a specific intra prediction mode. As described above in FIG. 17, the TIMD mode predictor may be determined based on determining two IPMs, from the plurality of IPMs, having the lowest costs of costs determined for the plurality of IPMs. Because the encoder and decoder reciprocally (e.g., independently and identically) determine the TIMD mode predictor, signaling of any specific intra prediction mode (IPM) may be omitted from the bitstream. At block 1812, the decoder generates a prediction block based on the determined TIMD mode predictor (e.g., as described in FIG. 17).

At block 1806, based on the indication of TIMD not being applied (e.g., disabled or not being selected), the decoder receives (e.g., parses) an indication of an intra prediction mode (IPM) from the bitstream. The indication may comprise a plurality of bits representing an index specifying the IPM from a list of IPMs (e.g., an MPM list). At block 1808, the decoder generates a prediction block based on the indicated IPM (e.g., as described in FIGS. 9-12). At block 1814, the decoder reconstructs the current block based on the prediction block and a residual, e.g., received from the bitstream.

The most probable mode (MPM) refers to the intra prediction mode that is most likely to be the best mode for the current block being encoded or decoded. In current intra prediction techniques, the MPM is determined by analyzing the intra prediction modes of the neighboring CUs. VVC uses a list of 6 MPMs (referred to as the “MPM list”) for luma intra prediction. The MPM list is derived from the intra prediction modes of the neighboring CUs, and is updated as the encoder progresses through the video frame. When encoding a block, the encoder may first check if the current block is a candidate for any of the MPMs in the MPM list. If it is, the encoder then compares the prediction errors of the respective MPMs to determine which MPM from the MPM list is the best mode for the current block. If the current block is not a candidate for any of the MPMs in the MPM list, the encoder may then evaluate all intra prediction modes (e.g., 67 in VVC) to determine the best mode for the current block.

The use of MPMs can significantly improve the coding efficiency of VVC. This is because the encoder does not need to signal the intra prediction mode for the current block if it is one of the MPMs. Instead, the decoder can infer the intra prediction mode for the current block from the corresponding MPM list.

Three types of intra modes are considered to construct the MPM list: default intra modes; neighboring intra modes; and derived intra modes. A unified 6 MPM list is used for intra blocks irrespective of whether Multiple Reference Lines (MRL) and Intra Sub-Partitions (ISP) coding tools are applied. The MPM list for the current block is constructed based on intra modes of the left neighbor block and the above neighbor block of the current block. Suppose the mode of the left neighbor block is denoted as Left and the mode of the above neighbor block is denoted as Above, the unified MPM list may be constructed as follows: when a neighboring block is not available, its intra mode is set to planar mode by default; if both modes Left and Above are non-angular modes, then the MPM list is set to include {planar, DC, V, H, V-4, V+4}, where “V” and “H” refer to vertical mode and horizontal mode, respectively; if one of modes Left and Above is an angular mode, and the other is non-angular, set a mode Max as the larger mode in Left and Above, and set MPM list to include {planar, Max, Max−1, Max+1, Max−2, Max+2}; if Left and Above are both angular and they are different, set a mode Max and a mode Min as the larger mode in Left and Above and as the smaller mode in Left and Above, respectively, and thereafter, if Max-Min is equal to 1, then set MPM list to include {planar, Left, Above, Min−1, Max+1, Min−2}, if Max−Min is greater than or equal to 62, then set MPM list to include {planar, Left, Above, Min+1, Max−1, Min+2}, if Max−Min is equal to 2, set MPM list to include {planar, Left, Above, Min+1, Min−1, Max+1}, or otherwise, set MPM list to include {planar, Left, Above, Min−1, −Min+1, Max−1}; and if Left and Above are both angular and they are the same, set MPM list to include {planar, Left, Left−1, Left+1, Left−2, Left+2}.

The encoder may encode an MPM index in the bitstream to indicate the position of the selected intra prediction mode in the MPM list to the decoder. The decoder may derive the MPM list in a manner identical to the encoder, and use the MPM index obtained from the bitstream to obtain the intra prediction mode from the MPM list derived at the decoder. In some instances, the first bin of the MPM index codeword is CABAC context coded so as to achieve additional coding efficiencies. Three contexts are used, corresponding to whether the current intra block is MRL enabled, ISP enabled, or a normal intra block.

During the 6 MPM list generation process, pruning can be used to remove duplicated modes so that only unique modes may be included into the MPM list. For entropy coding of the 61 non-MPM modes (that is, the 67 modes in VVC minus the 6 MPM), a truncated binary code (TBC) can be used.

In some implementations, the MPM list is extended to include 16 additional candidates, and is divided into two parts, the primary MPM (PMPM) (6 entries) and the secondary (SMPM) (16 entries). In some implementations, the first entry in the general MPM list is the planar mode. The remaining entries are composed of the intra modes of the adjacent neighboring blocks corresponding to positions left (L), above (A), below-left (BL), above-right (AR), and above-left (AL) (e.g., shown in FIG. 15A as A1, B1, A0, B0, and B2), and decoder-side intra mode derivation (DIMD) modes which are sorted in ascending order of a cost such as, for example, SAD, SSD, SATD, etc. Up to 5 modes with the smallest costs are added to the MPM list. The cost is computed between the prediction and the reconstructed samples of the template of the current block. Sorted directional modes are added into the general MPM list, and then the default modes, until the general MPM list with 22 entries is constructed. In some examples, if a CU block is vertically oriented, the order of neighboring blocks corresponds to A, L, BL, AR, AL; otherwise, it is L, A, AL, AR, BL.

Decoder-side Intra Mode Derivation (DIMD) is an intra coding mode where the intra prediction mode may not be transmitted in the bitstream (after being determined by the encoder, for example, by a rate distortion optimization (RDO) algorithm) but rather may be derived by using a gradient analysis of neighbor reconstructed pixels. That is, with DIMD, the intra prediction mode is implicit at the decoder. DIMD is signaled with a flag and the intra prediction mode is derived during the reconstruction process at the decoder in a manner that is identical to the manner in which the intra prediction mode is derived at the encoder. If DIMD is not selected at the encoder as the intra coding mode for the current block, the intra prediction mode may be parsed from the bitstream at the decoder as in an intra coding mode process that signals the intra prediction mode in the bitstream.

In DIMD, a 3-samples wide (in width or height) template area (composed of left, above, and above-left areas) of the current block is defined in which edge detection filters (e.g., 3×3 horizontal and vertical Sobel filters) adjacent to the current block are applied on all 3×3 window positions centered on the pixels of the middle line of the template area in order to determine the amplitude and the angle of luminance direction (orientation) for each middle line sample of the template area. A histogram of gradients (HoG) is computed where each entry in the HoG corresponds to a respective conventional intra angular mode. For example, where Gₕₒᵣ and Gᵥₑᵣ are the intensities of pure horizontal and vertical directions, respectively, as calculated using a Sobel filter at one 3×3 window position, an angle is calculated for the window as angle=arctan (Gₕₒᵣ/Gᵥₑᵣ). The calculated angle is converted into one of the angular intra prediction modes (e.g., one of the 65 angular intra prediction modes in VVC), and the corresponding amplitude (i.e., the amplitude for the window position) amplitude=|Gₕₒᵣ|+|Gᵥₑᵣ| is added to the HoG indexed by the respective intra prediction mode. Thus, when all window positions in the template area are calculated, each entry in the HoG represents the cumulated amplitude for a respective intra prediction mode.

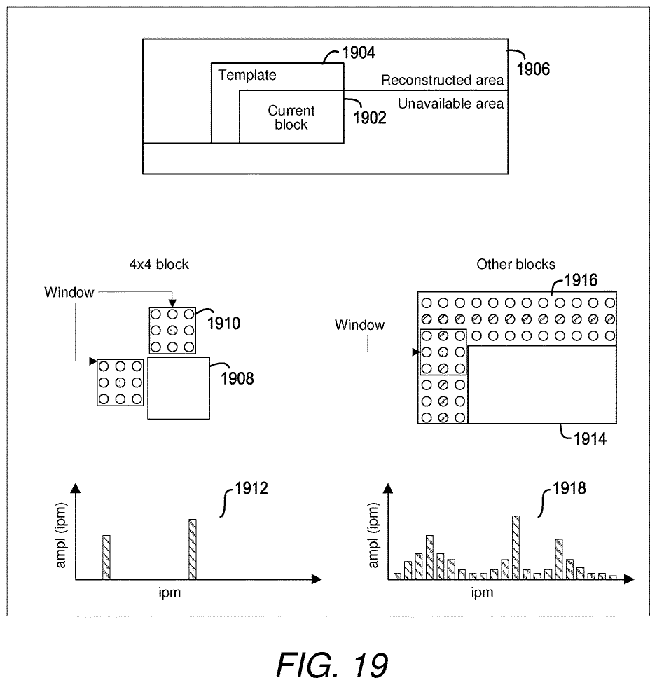

FIG. 19 shows an example of DIMD template region (e.g., template area) for computing a HoG in accordance with some embodiments. The reconstructed area 1906 relative to the current block 1902 is shown, as is a template area 1904 (e.g., an L-shaped template) of the current block 1902. An example 4×4 pixel square current block 1908 is shown with a 3×3 window 1910 in the template area. The HoG 1912 is the histogram corresponding to current block 1908. Another example is the rectangular current block 1914 with a 3-pixel deep template area 1916. The HoG 1918 corresponds to the rectangular current block 1914. As illustrated, each coordinate position on the x-axis of the illustrated HoG is a respective intra prediction mode (IPM), and the y-axis represents the cumulative amplitude (e.g., counts) for the respective intra prediction modes.

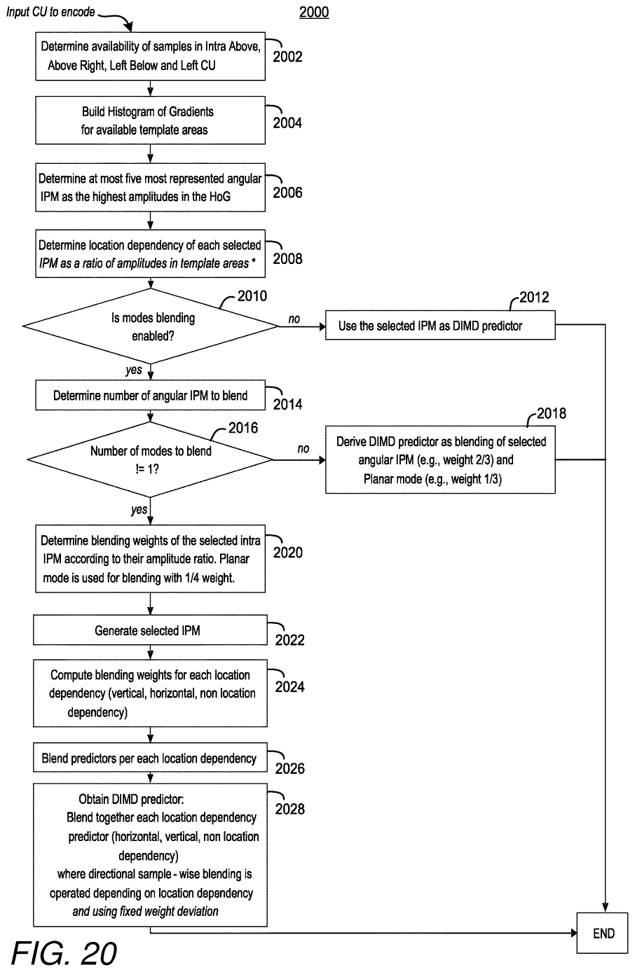

FIG. 20 shows a flowchart 2000 of an example DIMD predictor derivation process, according to some embodiments. Operations of flowchart 2000 may be performed reciprocally (e.g., identically) at the encoder (e.g., encoder 200) and the decoder (e.g., decoder 300). At 2002, the availability of samples in a template area, for example, in the neighboring blocks (CUs) above, above right, left below and left of the current block is determined. An example template area 1904 for a current block 1902 is shown in FIG. 19. At 2004, the HoG for available template areas is constructed. HoG construction for template areas is described above in relation to FIG. 19. At 2006, up to a predetermined number (e.g., 5) of the most represented intra prediction modes are identified based on the highest amplitudes in the HoG. At 2008, the location dependency of each identified intra prediction mode is determined as a ratio of amplitudes in template areas. In some implementations, the location dependency of an identified intra prediction mode can be determined as follows: default location dependency is set to 0 (i.e., no location dependency); if the intra prediction mode's amplitude in the left template (the sum of amplitudes for the identified intra prediction mode from samples in the template area to the left of the current block) is less than the intra prediction mode's average amplitude among all templates (e.g., among three template regions-left template, above template, and above left template), then the location dependency is set to 1 (vertical); else if the intra prediction mode's amplitude in the above template is less than the intra prediction mode's average amplitude among all templates, then the location dependency is set to 2 (horizontal). This calculation can be facilitated by, when generating the HoG, cumulating the amplitudes separately for each of the left template region, above template region, and above left template region in respectively different HoGs and then subsequently summing the three HoGs to determine the combined HoG for the entire template area.

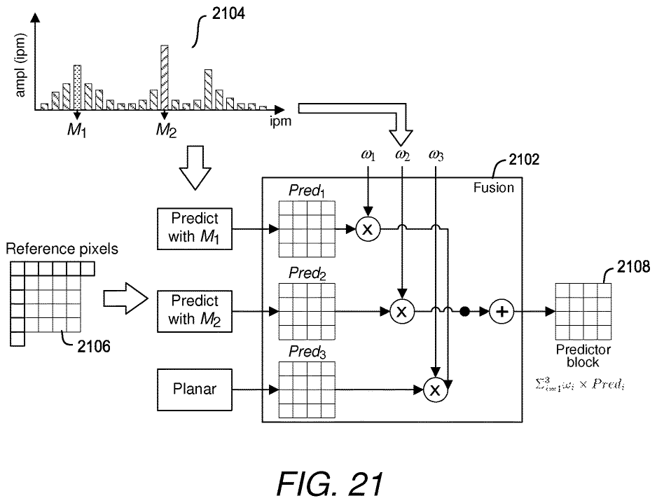

At 2010, it is determined whether mode blending is enabled. If mode blending is disabled, then at 2012 it is determined to use one of the identified intra prediction modes (e.g., corresponding to the highest amplitude) as the DIMD predictor. Alternatively, if it is determined at 2010 that mode blending is enabled, then at 2014, the number of angular intra prediction modes to be blended is determined. Mode blending may be enabled, for example, when the first and second identified intra prediction modes are both angular modes. At 2016, it is determined whether the number of modes to blend is greater than 1. If the number of modes to blend is not greater than 1, then at 2018, the DIMD predictor is determined by blending the one identified angular intra prediction mode and the planar mode (e.g., in weights ⅔ and ⅓, respectively). If at 2016, it is determined that the number of modes to be blended is more than 1, then at 2020, blending weights of the identified intra prediction modes are determined according to their amplitude ratios. The planar mode can be used for the blending with, for example, a ¼ weight. At 2022, the selected intra prediction mode is generated as the result of the blending of the identified intra prediction modes and the planar mode. As described below in relation to FIG. 21, the blending of identified intra prediction modes and the planar mode to derive the selected intra prediction mode for the current block may include computing all the identified intra prediction modes and the planar mode using neighboring reconstructed samples. In some implementations, the selected intra prediction mode determined at 2022 is used as the DIMD predictor for the current block.

Alternatively, some implementations may further use location-dependent blending modes to derive the DIMD predictor. The blending weights determined at 2020 are uniformly applied to all samples in the predictor and may be referred to as “uniform weights”. For location-dependent blending, for example, at 2024, sample-based weights for a predictor (e.g., for each identified DIMD intra prediction mode) are computed so that the average weight used within the block is approximately equal to the corresponding uniform weight (e.g., calculated at 2020) and so that higher weights are used in the portion of the block closer to the left template region or the above template region, depending on the location dependency of the DIMD intra prediction mode. A range is pre-defined, corresponding to the largest deviation of sample-based weights from the corresponding uniform weight. Higher values of the pre-defined range result in a higher variation of the weights within the block. After the blending weights for each location dependency (e.g., vertical, horizontal, no location dependency) are calculated at 2024, at 2026, predictions per each location dependency are blended. For example, for each of horizontal location dependency, vertical location dependency and no location dependency (i.e., diagonal location dependency) that is used by any of the identified intra prediction modes of the DIMD predictor, the identified intra prediction modes having that location dependency are blended based on their respective amplitudes. At 2028, the DIMD predictor is obtained by blending together the respective location dependency predictors (horizontal, vertical, no location dependency) in accordance with the respective sums of amplitudes of the identified intra prediction modes in each location dependency. This provides a directional sample-wise blending depending on location dependency and using fixed weight deviation as calculated at 2024.

In example implementations, the DIMD intra prediction mode determined at 2022 or 2028 may be added to a MPM list along with other intra prediction modes being considered for use on the current block. Subsequently, if it is determined, by a rate distortion cost calculation or the like, that the DIMD intra prediction mode is the best (i.e., most cost effective) intra prediction mode, then the current block is encoded using the DIMD intra prediction mode and only a flag indicating that the current block is encoded using DIMD is transmitted on the bitstream with the residual of the current block. The intra prediction mode is not transmitted in the bit stream. In example implementations, up to a predetermined number (e.g., 4) angular intra prediction modes are selected from the HoG and are combined (for example, as described in relation to 2020 or 2028 above) with the planar mode with weights derived from the selected angular intra prediction amplitudes' ratio (e.g., with planar having a ratio of ¼ i.e., 16/64 with 6 bits integer precision).

An example combining (also referred to as “fusion” or “blending”) of angular intra prediction modes from the HoG is shown in FIG. 21. In FIG. 21, the blending of two angular intra prediction modes and the planar mode is shown. Intra prediction modes M1 and M2 are selected for the current block 2106 based on the highest two peaks of the HoG 2104. The predicted block 2108 for the current block 2106 is determined in a combining (fusion) operation 2102 that combines predictions based on intra modes M1 and M2 and the planar mode, based on weights w1, w2, and w3. The weights before the respective angular intra prediction modes are determined according to the amplitudes of the corresponding gradients in the histogram and a predetermined weight can be used for the planar mode.

Since derived intra modes are included into the MPM list, the DIMD process is performed before the MPM list is constructed. The primary derived intra prediction mode of a DIMD block is stored with a block and is used for MPM list construction of the neighboring blocks. When DIMD is signaled, MPM and MRL, assumed to be 0, are not signaled.

Another example intra mode prediction technique involves merging the DIMD HoG information from neighboring blocks in order to predict the current block. When neighboring blocks encoded with DIMD are available, the DIMD histograms of the selected neighboring CUs are combined to form a merged histogram of gradients (MHoG) for the current block. DIMD modes and weights are derived from this merged histogram. The HoG of current block is not used in the construction of the MHoG.

The DIMD merge process is similar to the DIMD process that is described above in relation to FIG. 20, and may only differ from that process by including a set of operations that precedes 2010. In the proposed DIMD HoG merge process, at most 3 neighboring CUs are selected from up to 13 neighboring CUs that are available, coded as intra DIMD, and are spatially the closest to the current block. The HoG or merged HoG information of the selected neighbor CUs are retrieved. A merged HoG is calculated from the HoG (or merged HoG) of the selected CUs. The blended modes are identified depending on the merged HoG in the same manner as described above in relation to DIMD. Up to, e.g., 5, intra prediction modes are selected (e.g., based on the highest amplitudes in the merged HoG), as in the regular DIMD mode, and location dependency is determined. If multiple intra prediction modes are selected, the location dependency is set to 0 (diagonal), otherwise, the location dependency is set to the selected intra prediction mode's location dependency. The DIMD HoG merge mode intra prediction mode for the current block can be determined by combining the selected intra prediction modes. Decoder-side intra mode derivation is attractive at least partly because it can reduce the amount of information that is required to be signaled from the encoder to the decoder. In previous DIMD techniques, however, the DIMD modes and weights are derived from the reconstructed neighbor samples (the template areas) by computing gradients on a small 3×3 template size. This may often not yield the best neighbor because the further from the template area the current block samples are, the less likely it is that spatial correlation between template region and current block is high.

Moreover, unlike some other intra modes, DIMD (see FIG. 20) may not reuse neighbor information. Still further, the DIMD HoG merge may be considered only when at least one neighbor uses the DIMD mode (or DIMD HoG merge mode). As described above, the DIMD process is used by several intra prediction modes (especially non-angular modes, to retrieve direction information) and during the MPM list derivation process, even if the neighbor mode is not DIMD. Using correlations between blocks can improve compression efficiency. Consequently, the DIMD information from neighbor CUs can be further used to improve the intra mode efficiency.

The intra prediction processes, which were described above, provide 67 intra prediction modes (Planar, DC and 65 angular directions) for each prediction block. A luma intra prediction mode is selected for a luma prediction block and a chroma intra prediction mode is selected for the chroma prediction blocks. Mode-dependent reference and prediction sample smoothing is applied to increase prediction efficiency and the intra prediction mode is coded using either one of the 6 most probable modes (MPM) or one of the 61 remaining modes. It is noted that 28 wide angular modes (e.g., for a rectangular CU) may be used in replacement of regular modes.

For each CU predicted using the DIMD merge mode, embodiments include building a list of DIMD information and selecting one to be used to reconstruct the current block. This list, referred to as a “list of DIMD merge candidates,” is built from the DIMD information from various spatial neighbors (neighbor blocks in the current frame). As noted above, DIMD is used in the generation of the MPM list, so the DIMD information may already be available for most of the intra neighbor CUs (i.e., spatial neighboring blocks). In some embodiments, such neighbor CUs may include those which used DIMD HoG merge.

An initial list of DIMD merge candidates may be constructed according to a given checking order (also referred as “inclusion order”) of respective DIMD merge candidate families, such as, for example, DIMD information of spatial adjacent candidates, DIMD information of spatial non-adjacent candidates, DIMD information of history-based spatial candidates, DIMD information of combined candidates, and default DIMD information candidates.

In some embodiments, the list of DIMD merge candidates may have a predetermined maximal number of DIMD merge candidates, and the generation process can be stopped when the maximal number is reached (i.e., when the list is full). Moreover, the generation of the list may ensure that no DIMD merge candidates with duplicate DIMD information is added to the list. The list generation process may also ensure that the number of DIMD merge candidates from each family of DIMD merge candidates does not exceed a predetermined maximal threshold.

Once the list is completed, a DIMD merge candidate with the DIMD information that is best for the current block is selected. At the encoder, this selection may be based upon a rate distortion cost of the selected DIMD merge candidate. The selected DIMD merge candidate can be derived at the decoder in accordance with an indicator that is signaled by the encoder. This indicator indicates which entry of the list of DIMD merge candidates (i.e., which candidate from the constructed list) is to be used to process the block reconstruction. In the list of DIMD merge candidates, all DIMD information from spatial neighbor blocks needed to reconstruct the current block are stored, for example: the intra prediction modes to be blended, the corresponding blending weights, and location dependency information. This DIMD information defines a DIMD merge candidate and may be referred to as “DIMD parameters”. In some embodiments, additional information, such as, for example, HoG information may be included in the DIMD parameters.

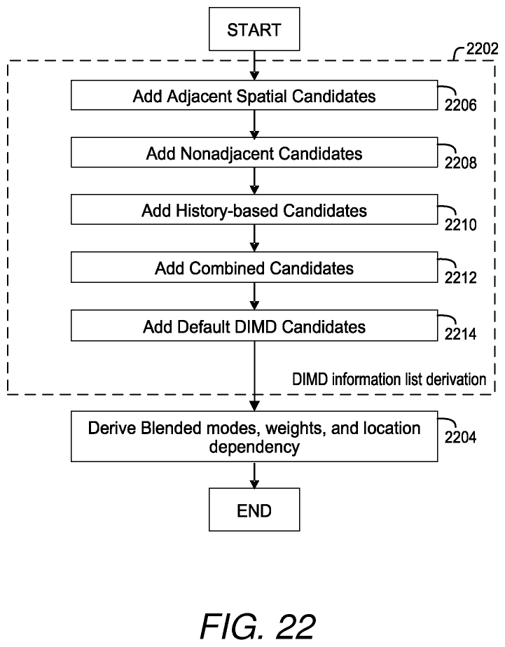

FIG. 22 shows an example flowchart 2200 of a method for an intra coding prediction mode, DIMD merge mode, according to some embodiments. The method of flowchart 2200 comprises a DIMD merge information derivation operation 2202 and an operation 2204 to derive blended modes, weights, and location dependency. The method may be performed by an encoder, such as, for example, encoder 200 in FIG. 2, or by a decoder, such as, for example, decoder 300 in FIG. 3.

The method begins at 2202. The DIMD merge information derivation at 2202 may include several operations such as 2206-2216 each of which may add to the list of DIMD merge candidates a family of DIMD merge candidates obtained from spatial neighbor blocks (i.e. intra blocks) of the current block that are selected based on a different selection criterion, from combinations of DIMD information already in the list, or from configured default DIMD information. In some embodiments, the DIMD merge candidates in the list of DIMD merge candidates is arranged as a list or table, but embodiments may not be limited by a specific arrangement structure of the DIMD merge candidates.

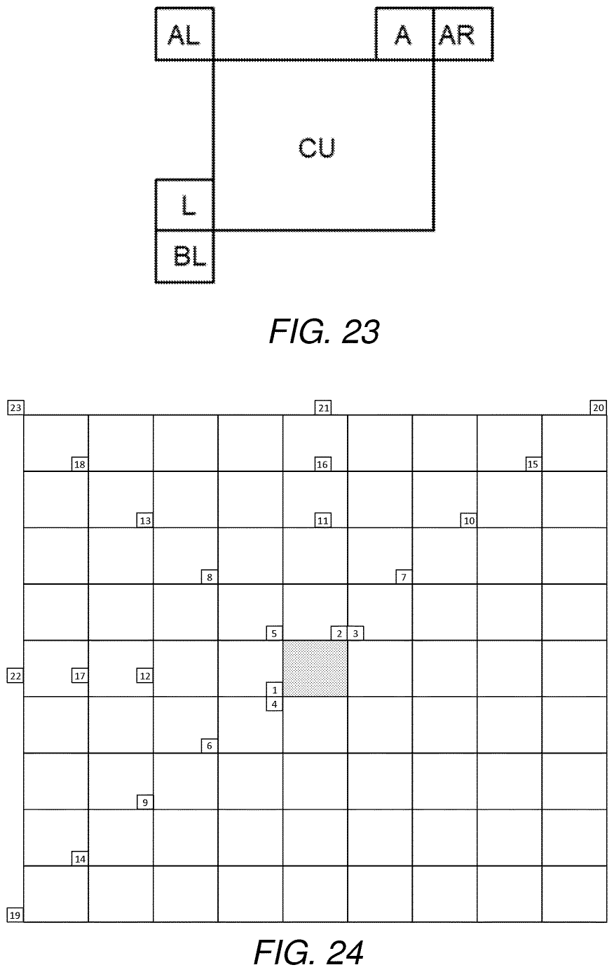

At 2206, DIMD merge candidates from a family of spatial adjacent blocks is considered for adding DIMD merge candidates to the list of DIMD merge candidates. FIG. 23 shows adjacent neighbor samples of a current block (CU) that correspond to blocks in the family of spatial adjacent blocks of the current block. In some embodiments, the DIMD merge candidates from spatial adjacent blocks can be added to the list of DIMD merge candidates according to the inclusion order of blocks corresponding to left sample (L), above sample (A), above left sample (AL), above right sample (AR), and bottom left sample (BL). In some embodiments, another inclusion order such as, L, A, AR, BL, and AL, or yet another different inclusion order may be used. The blocks in the family of spatial adjacent blocks are also considered in the derivation of the MPM list. Between 1 and 5 (all spatial adjacent neighbors) candidates may be added to the DIMD merge candidate list at 2206. For the DIMD information of a particular spatial block to be included in the DIMD merge candidate list, that block must at least already have had (i.e., during the reconstruction of blocks in the current frame) DIMD information derived for that block. DIMD information may be derived for a block for DIMD or another intra prediction mode that uses the DIMD parameters such as, for example, DIMD HoG merge mode, DIMD merge mode, and MPM list derivation. In some embodiments, a merge candidate is added to the list of DIMD merge candidates only if the corresponding neighbor block was encoded or decoded based on DIMD or another intra prediction mode that uses the DIMD parameters. In some instances, such as when none of the adjacent spatial adjacent blocks are reconstructed using DIMD mode, DIMD HoG merge mode, or DIMD merge mode, or had derived DIMD information, 2206 may not add any candidates to the list of DIMD merge candidates.

At 2208, DIMD merge candidates from a family of spatial non-adjacent blocks of the current block are added to the list of DIMD merge candidates. The positions and inclusion order of the DIMD merge candidates of non-adjacent candidates in the same frame as the current block may be in accordance with a predetermined sequence, such as that, for example, shown in FIG. 24. The pattern and sequence of blocks indicated in FIG. 24 is the same as that defined in some implementations for inter-merge prediction candidates.

As shown in FIG. 24, the numbers 1-5 refer to spatially adjacent neighbors of the current block (shown shaded) in the inclusion order L, A, AR, BL, and AL, that were already added to, or otherwise considered for inclusion in, the merge candidate list at 2206 and thus may not be considered at 2208. The sequence of blocks indicated by the numbers 6-23 may be considered for inclusion of the corresponding DIMD information in the list of DIMD merge candidates at 2208. As can be seen in FIG. 24, the non-adjacent neighbors 6-23 considered for inclusion in the list of DIMD merge candidates at 2208 are arranged in the frame along the left horizontal direction, the above vertical direction, the above left diagonal direction, the above right diagonal direction, and below right diagonal direction.

For the DIMD information of a particular spatial non-adjacent block to be included in the list of DIMD merge candidates, that block must have had DIMD used for encoding/decoding or at least have had DIMD information derived for that block. DIMD information may be derived for a block for encoding/decoding based on DIMD or another intra prediction mode that uses the DIMD parameters such as, for example, DIMD HoG merge mode, DIMD merge mode, and MPM list derivation. In some embodiments, a candidate is added to the list of DIMD merge candidates only if the corresponding neighbor block was reconstructed based on DIMD or another intra prediction mode that uses the DIMD parameters. In some instances, such as when none of the adjacent spatial candidates were encoded/decoded using DIMD, DIMD HoG merge, or DIMD merge, or had derived DIMD information, 2208 may not add any candidates to the list of DIMD merge candidates.

At 2210, a family of merge candidates from a history-based table of DIMD information are added to the list of DIMD merge candidates. The history-based table may be maintained to include recently used DIMD information of intra blocks. This history-based table can be updated each time a CU intra prediction mode uses the DIMD process, i.e., when the DIMD information is derived (e.g., a block using the DIMD mode, or an MPM-based mode, or based on a direction derived from DIMD, or a DIMD HoG merge mode, or DIMD merge mode). This table includes a limited number of entries of DIMD information from previous blocks and does not include any duplicate DIMD information.

For the DIMD information of a particular spatial block to be included in the history-based table, that block must have had DIMD used for encoding/decoding or at least have had DIMD information derived for that block. DIMD information may be derived for a block for encoding/decoding based on DIMD or another intra prediction mode that uses the DIMD parameters such as, for example, DIMD HoG merge mode, DIMD merge mode, and MPM list derivation. In some embodiments, an entry of DIMD information is added to the history-based table only if the corresponding neighbor block was reconstructed based on DIMD or another intra prediction mode that uses the DIMD parameters. In some embodiments, since example embodiments may separately consider spatial adjacent blocks and spatial non-adjacent blocks in accordance with a predetermined inclusion order, only DIMD information of spatial blocks that are neither spatial adjacent blocks nor spatial non-adjacent blocks according to the predetermined inclusion pattern are added to the history-based table.

When inserting a new entry of DIMD information into the history-based table, a constrained first-in-first-out (FIFO) rule may be utilized where a redundancy check is first applied to determine whether there is identical DIMD information in the table. If found, the entry with the identical DIMD information is removed from the table and all entries following that in the table are moved forward in the FIFO order, and the new DIMD information is inserted as the last entry. The table could be reset at intervals, such as, for example, at the beginning of each CTU row. Such resetting may be performed due to hardware constraints. Such resetting may also help ensure that only the most recent neighbor blocks are in the table. In some embodiments, the history-based table of DIMD information may be similar to the history-based table of motion vectors (HMVP) in the whole-block-based Advanced Motion Vector Predictor (AMVP) mode for inter prediction in VVC.

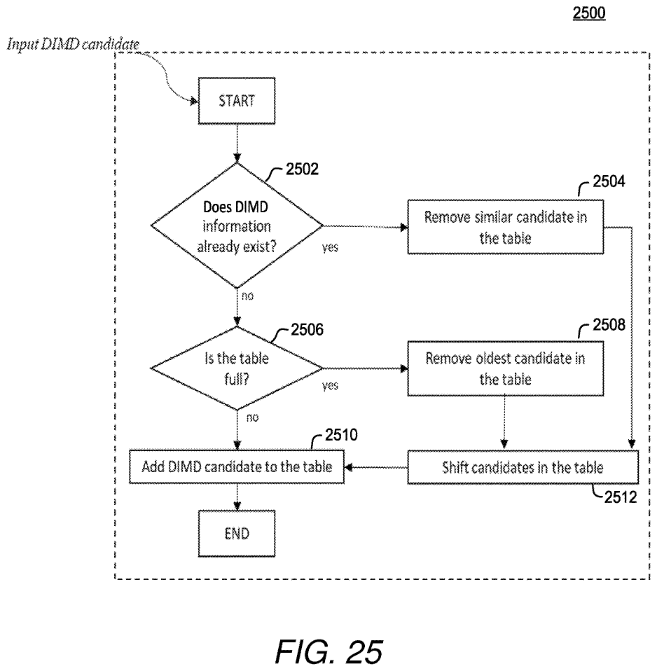

FIG. 25 is a flowchart 2500 of a method for adding DIMD information to the history-based table, according to some embodiments. Operations of flowchart 2500 may be performed reciprocally at the encoder (e.g., encoder 200) and the decoder (e.g., decoder 300). The method of flowchart 2500 begins at 2502 upon considering the DIMD information of a DIMD merge candidate for input to the history-based table. Such a consideration may occur whenever a spatial neighbor block uses DIMD or other intra mode in which DIMD information is derived. At 2502, it is determined whether the DIMD information to be added already exists in the table. If, at 2502, it is determined that the DIMD information to be added is not in the table, then at 2506, it may be determined whether the table is full. This determination may be based on a preconfigured maximum size threshold for the history-based table. If the table is not full, at 2510, the DIMD information to be added is added to the history-based table.

If at 2502, it is determined that the DIMD information to be added is in the table, then at 2504, the duplicate DIMD information already in the table is removed from the table. If at 2506 it is determined that the history-based table is full, at 2508, the oldest entry in the table is removed. After either 2504 or 2508, at 2512, the entries that follow the removed entry in the table are shifted up or moved up in sequence (e.g., in the FIFO sequence). After the rearrangement of table entries at 2512, at 2510, the new DIMD information is added as the last entry in the table. According to the example inclusion order, DIMD merge candidates derived from DIMD information in the history-based table are added to the list of DIMD merge candidates after considering DIMD merge candidates derived from spatial adjacent blocks and spatial non-adjacent blocks of the current block.

Returning to FIG. 22, at 2212, a set of combined DIMD merge candidates are added to the list of DIMD merge candidates, according to some embodiments. Once the potential DIMD merge candidates, or more particularly their respective DIMD information, of all spatial adjacent, spatial non-adjacent, and history-based spatial neighbors have been considered for inclusion in the list of DIMD merge candidates, combined DIMD information may be added to the list of DIMD merge candidates. This process includes combining DIMD information from the DIMD information of DIMD merge candidates that are already in the list of DIMD merge candidates. DIMD merge candidates that are already in the list, but which are based on a combination of other DIMD merge candidates in the list, are not used to derive further combined DIMD merge candidates.

In some instances, HoGs from at least two DIMD merge candidates in the list of DIMD merge candidates are combined to create a new combined HoG, from which the blending modes and weights are derived to obtain the DIMD information of a new DIMD merge candidate. For example, the HoGs of at least two merge candidates are averaged, and the blending modes and weights are derived from this averaged HoG in a manner similar to that in the blending mode derivation in DIMD, as described, for example, in relation to FIG. 20. Considering the new combined DIMD merge candidate, location dependency is set for example to diagonal (0) as a default value, or can be set accordingly to the blending modes, i.e., that a vertical location dependency is set for a vertical blended mode, or a horizontal location dependency is set for a horizontal blended mode.

Combined DIMD merge candidates may be derived as follows: a candidate derived from the first and second DIMD merge candidates in the list of DIMD merge candidates; a candidate derived from the first and third DIMD merge candidates in the list of DIMD merge candidates; a candidate derived from the second and third DIMD merge candidates of the list of DIMD merge candidates; a candidate derived from the two first DIMD merge candidates of the list of DIMD merge candidates with a vertical location dependency; a candidate derived from the two first DIMD merge candidates of the list of DIMD merge candidates with a horizontal location dependency; or a candidate derived from combining DIMD information of all spatially adjacent blocks of the current block.

Alternatively or additionally, in some embodiments, the output DIMD information of the DIMD HoG merge mode is added as a combined candidate to the list of DIMD merge candidates. In some examples, a merge candidate is not added to the list if it cannot be derived. For example, if there are only two candidates in the list of DIMD merge candidates before adding combined candidates, the second combined candidate, derived from the first and third candidates is skipped as there is no third candidate.

At 2214, a set of default DIMD merge candidates are added to the list of DIMD merge candidates, according to some embodiments. One or more default DIMD information entries are added as DIMD merge candidates to the list of DIMD merge candidates. For example, a default mode 0 and default mode 1 may each specify a set of predetermined DIMD parameters. One or more DIMD merge candidates having predetermined default DIMD information may be added to the list of DIMD merge candidates based on the DIMD parameters. The addition, if any, of combined merge candidates optionally followed by the default merge candidates completes the addition of merge candidates to the list of DIMD merge candidates.

Operation 2202, which includes 2206-2214 and which generates the list of DIMD merge candidates, may be identical at both the encoder and decoder. After 2202 is completed (i.e., the list of DIMD merge candidates is constructed), at 2204, blended modes, weights and location dependency are derived. At the encoder, this may include determining the best DIMD merge candidate in the list of DIMD merge candidates based on a cost (e.g., SAD, SATD, etc.) difference between a predicted block obtained using the DIMD predictor and the current block and/or based on rate distortion optimization of each of the DIMD merge candidates starting from the top (e.g., the lowest SAD, SATD cost) of the list of DIMD merge candidates. The index to the position of the best (selected) DIMD merge candidate in the list of DIMD merge candidates is determined. Subsequently, in some embodiments, the selected predictor may be added to the MPM list. If the current block is predicted by the DIMD predictor and encoded for transmission based on the DIMD prediction, then a DIMD enabled flag and the index can be transmitted on the bitstream. At the decoder, 2204 may include parsing the bitstream for one or both of a DIMD enabled flag or index to the list of DIMD merge candidates. The index can be used to obtain the selected DIMD merge candidate from which to derive the DIMD predictor.

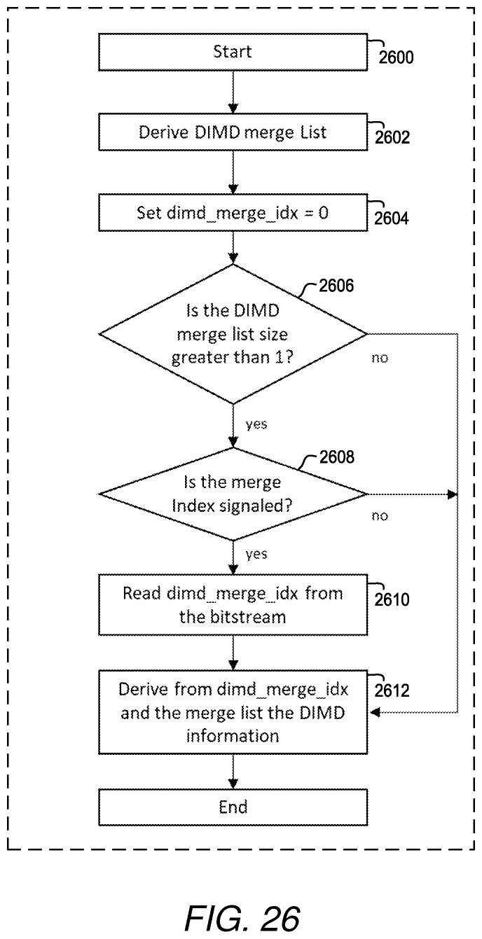

FIG. 26 is a flowchart 2600 of a method for determining the index into the list of DIMD merge candidates, according to some embodiments. The method may be performed at a decoder, such as, for example, decoder 300 in FIG. 3. Considering the DIMD merge mode, an index referring to an entry in the list of DIMD merge candidates (which is both identically derived at the encoder and decoder sides) is signaled or derived. To proceed to the signaling of the DIMD merge index, one or more indicators may be signaled from the encoder to the decoder. A DIMD merge enabled flag is a syntax element to signal if a DIMD merge index is signaled, and a DIMD merge index is a syntax element to signal the DIMD merge index.

The DIMD merge index, referring to the candidate in the DIMD merge candidates list to use to reconstruct the block pixels (also referred to as the selected candidate), may be derived at the decoder for the following two cases. When the DIMD merge candidates list size is one, i.e., there is only one candidate in the list, it is then possible to bypass the index signaling as the index can be derived to DIMD merge index=0. Moreover, when the DIMD merge enabled flag is signaled, but is equal to zero, it can be derived that there is no DIMD merge index to extract from the bitstream and that DIMD merge index is set to the default value, zero.

For all other cases, the DIMD merge enabled flag equals 1 and a DIMD merge candidates list size larger than one, the DIMD merge index is decoded from the bitstream. Optionally, the DIMD merge enabled flag syntax element may be discarded. In this case, when the DIMD merge candidates list size is greater than one, i.e., the DIMD merge index is not derived, the DIMD merge index is read from the bitstream.

After the list of DIMD merge candidates is derived at 2602, the DIMD merge index is initialized to 0 at 2604. At 2606, it is determined whether the list of DIMD merge candidates has more than one entry. If yes, then at 2608, it is determined whether the merge index is signaled. If the response is yes at 2608, then at 2610, the DIMD merge index is read from the bitstream. At 2612, the selected DIMD merge candidate is derived by accessing the merge candidates list using the DIMD merge index.

If at 2606, it is determined that the merge candidates list size is 1, then the method proceeds to 2612 to derive the selected DIMD merge candidate based on the DIMD merge index of 0. If at 2608, it is determined that the DIMD merge index is not signaled, then the method proceeds to 2612 to derive the selected DIMD merge candidate based on the DIMD merge index of 0.

According to some embodiments, the DIMD merge mode operations at a decoder, such as, for example, decoder 300 in FIG. 3, may begin when an encoded video bitstream comprising encoded video data and associated DIMD information is received. A DIMD enabled flag and, optionally, a DIMD index, may be parsed from the bitstream. For each encoded video frame, each CTU in the frame is decoded. For each CU in the CTU, if DIMD merge mode is enabled, a list of DIMD merge candidates is constructed. The construction of the list of DIMD merge candidates may include adding DIMD information from spatial adjacent blocks, spatial non-adjacent blocks, from a history-based table, from combinations of DIMD merge candidates, and/or default DIMD information. In some embodiments, a reordering of the merge candidate list may be optionally performed. The DIMD parameters are derived from the DIMD merge candidates list using the index signaled (if signaled) in a bitstream. Thereafter, the DIMD predictor is generated according to determined blending weights, modes, and predictors location-dependency states.

According to some example embodiments, DIMD merge mode operations at an encoder, such as, for example, encoder 200 in FIG. 2, may be performed for each encoded video frame. For each CU in each CTU in the frame, if DIMD is enabled, a list of DIMD merge candidates is constructed. The construction of the list of DIMD merge candidates may include adding DIMD information from spatial adjacent blocks, spatial non-adjacent blocks, from a history-based table, from combinations of DIMD merge candidates, and/or default DIMD information. Subsequently, the best DIMD merge candidate is selected. The selection may include generating a DIMD predictor for each (or some) DIMD merge candidate from the list of DIMD merge candidates according to determined blending weights, modes, and predictors location-dependency states. Based on each predictor, a cost difference (e.g., SATD, SAD, etc.) between the prediction and reconstruction samples of the template is calculated, and, based on the minimum cost, the best DIMD merge candidate is selected and the corresponding index in the list of DIMD merge candidates is determined. In some embodiments, the best DIMD merge candidate is added to a list of candidate intra modes (e.g., the MPM list) that are to be considered for the CU. Subsequently, if the best DIMD information is selected from the candidate list for encoding the CU, then the index may be transmitted in a bitstream with an indication that DIMD merge mode is enabled (e.g., that the current block is encoded in the DIMD merge mode).

In some embodiments, to improve the relevance of the list of DIMD merge candidates, a potential DIMD merge candidate is added to the list only if its DIMD information differs from all DIMD information already in the list. For example, if a candidate has been derived from the left block (L), and the left block and the bottom left block (BL) have the same DIMD parameters, e.g., the blending modes, the blending weights, and the location dependency, the BL block's DIMD information is not added as a new DIMD merge candidate in the list of DIMD merge candidates. As another example, if a preconfigured default DIMD information has the same DIMD parameters as a candidate in the list of DIMD merge candidates, the preconfigured default DIMD information is not added to the list.

In some embodiments, the list of DIMD merge candidates is limited to a preconfigured maximum list size. Additionally, or alternatively, respective sets of DIMD merge candidates (e.g., each family such as candidates from spatial adjacent blocks, spatial non-adjacent blocks, a history-based table, combination of candidates, and default DIMD information) may be configured with a maximum number of candidate entries.

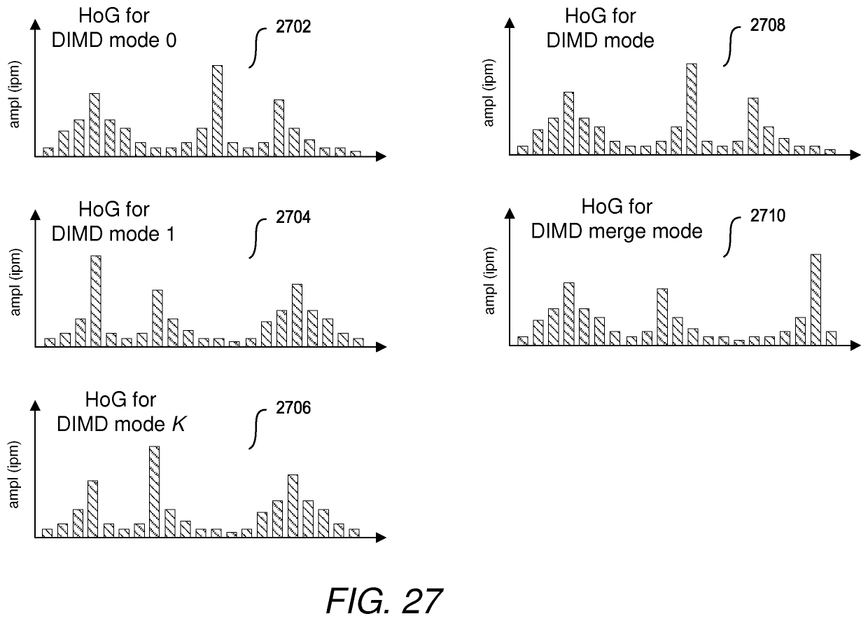

FIG. 27 shows example histograms of gradients (HoGs) for a plurality of DIMD modes and DIMD merge mode, according to some embodiments. As described in detail above, Decoder-side Intra Mode Derivation (DIMD) is a type of intra prediction mode that may be applied by an encoder or decoder. When DIMD is applied, up to five intra modes are derived from the reconstructed neighbor samples, and those five predictors are combined with the planar mode predictor with the weights derived from the histograms of gradients (HOGs) as shown in FIG. 21 as well as in FIG. 27. For example, a plurality of HoGs may comprise: as indicated by 2702, a HoG for DIMD Mode 0; as indicated by 2704, a HoG for DIMD mode 1; and, as indicated by 2706, a HOG for DIMD mode K. These HoGs 2702, 2704, and 2706 may be combined according to weights in order to derive a HoG for DIMD mode 2708. Further, a HoG for DIMD merge mode 2710 (DIMD merge mode being described in more detail hereinabove) may be similar to HoG for DIMD mode 2708.

The division operations involved in the weight derivations may be performed utilizing a lookup table (LUT) scheme, e.g., used by the CCLM, to integerize the division operations. For example, the division operation in the orientation calculation (22):

Orient=G_{y}/Gₓ (22)

may be based on a LUT-based scheme in order to, for example, reduce complexity.

For a block of size W×H, the weight for each of the five derived modes is modified if one of the above or left histogram magnitudes is twice as large as the other one. In this case, the weights are location dependent and computed as follows. For example, if the above histogram is twice the left, then the weights are calculated according to (23)

$${w}_{i} ( x , y ) = wDim {d}_{i} + {Δ}_{i} - 2 {Δ}_{i} \frac{y}{( H - 1 )} \qquad ( 23 )$$

Further, for example, if the left histogram is twice the above, then the weights are calculated according to (24):

$${w}_{i} ( x , y ) = wDim {d}_{i} + {Δ}_{i} - 2 {Δ}_{i} \frac{x}{( W - 1 )} \qquad ( 24 )$$

where wDimdᵢ is the unmodified uniform weight of the DIMD as selected, and Δᵢ is pre-defined and set to 10.

Derived intra modes are included into the primary list of intra most probable modes (MPM), so the DIMD process is performed before the MPM list is constructed. The primary derived intra mode of a DIMD block is stored with a block and is used for MPM list construction of the neighboring blocks. Further, as illustrated in FIG. 21, the region of neighboring reconstructed samples used for computing the histogram of gradients (HoG) may be modified depending on the availability of reconstructed samples. For example, the region of decoded reference samples of current W×H luma CB may be extended towards the above-right side if available, up to W additional columns. Further, for example, the region of decoded reference samples of current W×H luma CB may be extended towards the bottom-left side if available, up to H additional rows.

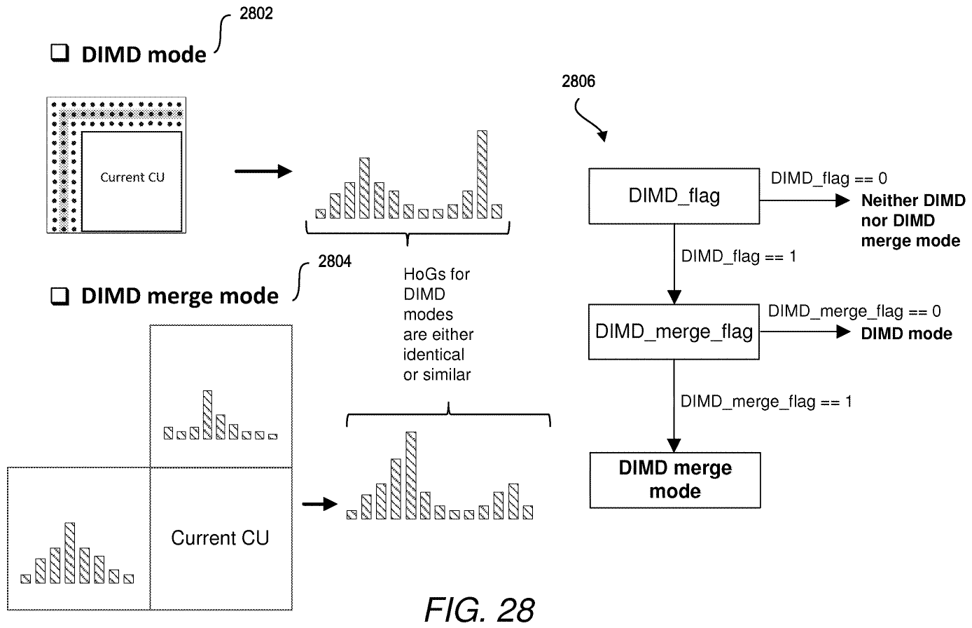

FIG. 28 shows example HoGs for DIMD mode and DIMD merge mode including similar HoGs for DIMD modes signaled according to flags or indications in a bitstream, according to some embodiments. FIG. 28 shows a comparison between DIMD mode 2802 and DIMD merge mode 2804. When using DIMD merge mode 2804, the DIMD information extracted from neighbouring blocks is used to compute the intra prediction for the current block. In particular, a Merged Histogram of Gradients (MHoG) is computed for the current block based on the HoGs of neighbouring blocks. In some examples, only neighbouring blocks encoded with DIMD or with DIMD Merge may be considered for the MHoG.

In some examples, DIMD Merge mode may only be available as an option if the current block has at least one neighbour that is coded with intra prediction such as DIMD or DIMD Merge. Thus, adding DIMD merge mode introduces such cases where two DIMD modes are available as shown in FIG. 28. Under these conditions, usage of DIMD Merge may be signaled with a CABAC coded CU-level flag. An additional CABAC context may be included to support coding of the DIMD Merge flag. Regarding the signaling of DIMD modes, indicated by 2806 in FIG. 28, DIMD Merge may be considered a sub-mode of DIMD. For example, the DIMD Merge flag may be signaled as true (e.g., DIMD_merge_flag==1) only if DIMD_flag==1 (e.g., indicating that a DIMD related mode is to be used) and if there are neighbouring blocks (CUs) that are coded with DIMD or DIMD Merge. Further, the Merged Histogram of Gradients (MHoG) may be used to compute intra prediction modes and weights, as in DIMD mode. The directional modes and their weights corresponding to the five highest amplitudes in the MHOG are selected, and the corresponding predictors are blended as in DIMD mode.

In another example, when more than one neighboring blocks encoded with DIMD or DIMD merge are available, then their HoGs are combined by averaging the five highest amplitudes from their respective histograms in order to reduce the requirements for internal memory size needed for storing HoGs of neighboring blocks. Thus, only the five highest amplitudes may be stored for a DIMD CU.

In another example, as shown in FIG. 24 and discussed in detail above, non-adjacent spatial candidates may be used to construct a DIMD merge candidates list. As shown in FIG. 24, the distances between non-adjacent candidates and current block may be defined based on the width and height of current coding block. When DIMD merge mode is applied, the DIMD information extracted from neighboring blocks and non-adjacent spatial blocks may be used to compute the intra prediction for the current block.

In existing technologies, the predictor generation process for DIMD merge mode may be substantially the same as DIMD mode. Consequently, the same reference samples and weight derivation mechanisms may be used in DIMD mode and DIMD merge mode, and the prediction result may thus significantly depend on the HoGs obtained for the DIMD modes. Further, if DIMD mode and DIMD merge modes produce identical or similar HoGs, as shown in FIG. 28, both modes may result in identical or similar predictors even though an additional syntax element (e.g., DIMD_merge_flag) was added into a bitstream to switch between these DIMD modes. Thus, this design causes redundancy in the output bitstream that reduces the compression performance of the intra prediction schemes of the video codec.

Embodiments of the present disclosure are related to an approach for diversifying decoder-side intra mode derivation (DIMD) merge candidates. In an example embodiment, a video decoder receives (or obtains), in a bitstream, a first indication of a decoder-side intra mode derivation (DIMD) prediction mode being enabled for predicting a current block. The decoder determines, based on the first indication, a first histogram of gradients (HoG) based on the current block and a second HoG based on a neighboring block of the current block. The decoder determines a value representing a similarity between the first HoG and the second HoG. The decoder selects, for the DIMD prediction mode and based on comparing the value with a threshold value, a set of parameters from a first set of parameters and a second set of parameters. The decoder generates a DIMD predictor based on the set of parameters. And the decoder decodes the current block based on the DIMD predictor.

In another example embodiment, a video encoder determines a decoder-side intra mode derivation (DIMD) prediction mode for encoding a current block. The encoder encodes, in a bitstream, a first indication of the DIMD prediction mode. The encoder determines, based on the first indication, a first histogram of gradients (HoG) based on the current block and a second HoG based on a neighboring block of the current block. The encoder determines a value representing a similarity between the first HoG and the second HoG. The encoder selects, for the DIMD prediction mode and based on comparing the value with a threshold value, a set of parameters from a first set of parameters and a second set of parameters. The encoder generates a DIMD predictor based on the set of parameters. And, the encoder encodes the current block based on the DIMD predictor.

These and other features of the present disclosure are described further below.

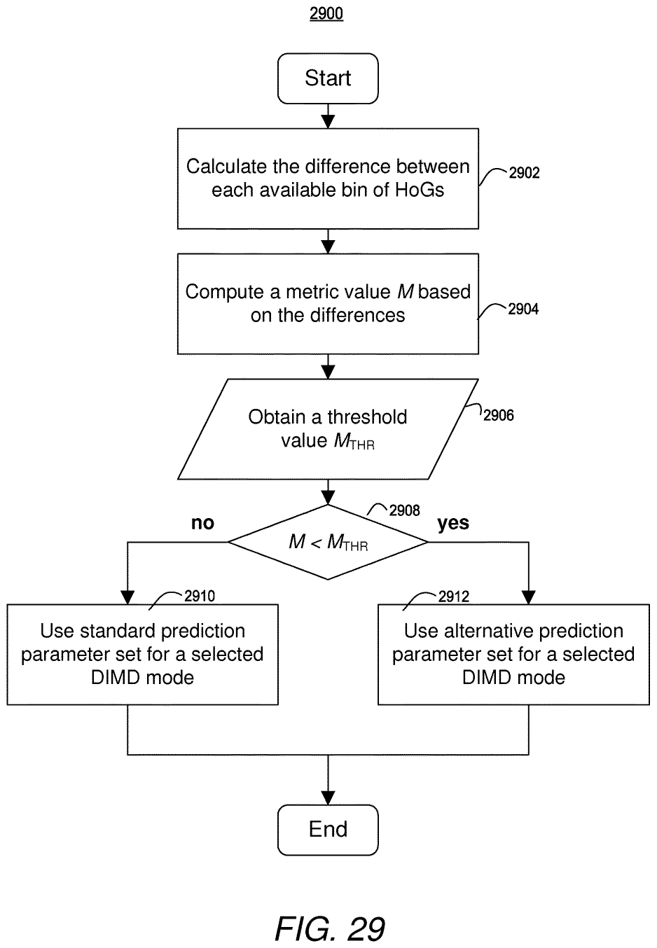

FIG. 29 shows a flowchart of an example process for diversifying decoder-side intra mode derivation (DIMD) merge candidates, according to some embodiments. In an example, the similarity of HoGs obtained for different DIMD modes, e.g., for DIMD mode and DIMD merge mode, is estimated in order to determine a set of prediction parameters. In FIG. 29, flowchart 2900 illustrates example steps 2902, 2904, 2906, 2908, 2910, and 2912. At 2902, the differences between each available, corresponding bin of the HoGs are calculated. For example, each of the differences mi between bins corresponding to the same angular prediction mode i may be calculated.

At 2904, a metric value M is computed based on the differences, which is used as indication of similarity between the differences of the HoGs. Further, for example, to estimate the difference with respect to the entire HoGs, a metric value M may take into account all the values mi. For example, a Minkowski distance may be used for metric value M, calculated according to (25) below.

$$M = {\sum }_{i = 0}^{N - 1} abs ( {m}_{i} ) \qquad ( 25 )$$

Other types of difference metrics (e.g., Manhattan distance or Euclidean distance, etc.) may be used to calculate the metric M value.

At 2906 a threshold value MTHR is obtained. At 2908, the metric value M is compared to the threshold value MTHR. If the metric value M is not less than the threshold value MTHR, for example, the HoGs are not substantially similar, then at 2910 a standard prediction parameter set may be utilized for the selected DIMD mode. Further, if the metric value M is less than the threshold value MTHR, for example, the HoGs are substantially similar or identical, then at 2912 an alternative prediction parameter set may be utilized for the selected DIMD mode.

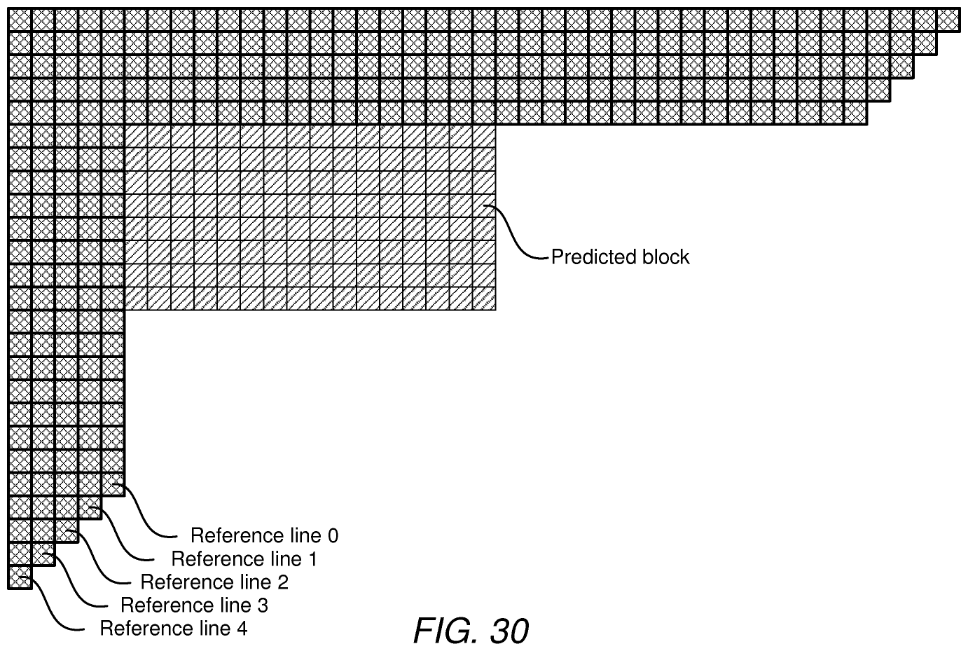

FIG. 30 shows an example of multiple reference lines (MRLs) with respect to a predicted block being coded in a DIMD mode, according to some embodiments. For the alternative set of prediction parameters, to diversify DIMD predictors, various mechanisms might be applied including utilizing non-adjacent reference lines as shown in FIG. 30, and/or by applying non-default weights to the planar mode. An example of non-adjacent reference lines illustrated in FIG. 30 may include selecting reference line 0, reference line 2, and reference line 4 for the alternative parameter set for a selected DIMD mode for predicting a current block. Additional details for MRLs are further described above with respect to FIG. 11.

In some examples, instead of using reference line 0 to generate predicted block, a non-adjacent reference line (e.g., one of reference lines 1-4) may be used to generate the predicted block.

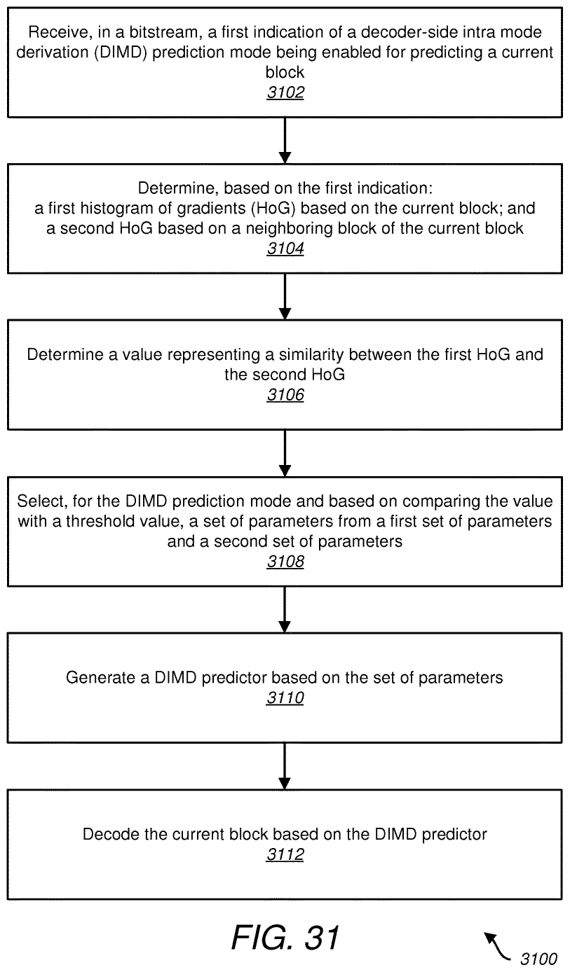

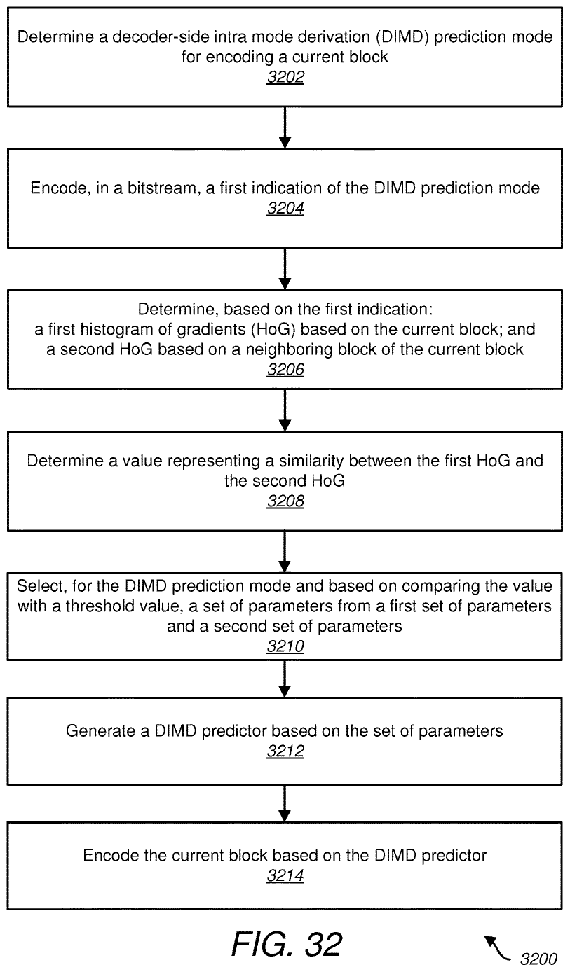

The examples discussed above with respect to FIG. 29 and FIG. 30 may be applicable to any case when the number of available DIMD modes is more than 1. For example, if several (e.g., more than 1) DIMD merge modes that use different ways of computing MHoGs are available, as shown in FIG. 27 by 2702, 2704, and 2706, prediction parameters may be diversified by associating the prediction parameters with different reference lines or by assigning different weights to planar mode. The example process described above with respect to FIG. 29 is discussed in further detail below, with regard to example operations of a decoder in FIG. 31, and example operations of an encoder in FIG. 32.

FIG. 31 shows a flowchart 3100 of a method for diversifying decoder-side intra mode derivation (DIMD) merge candidates by a decoder, according to some embodiments. The method of flowchart 3100 may be implemented by a decoder, such as decoder 300 in FIG. 3.

The method of flowchart 3100 begins at 3102. At 3102, a decoder receives, in a bitstream, a first indication of a decoder-side intra mode derivation (DIMD) prediction mode being enabled for predicting a current block. In some examples, the receiving, in the bitstream, the first indication of the DIMD prediction mode may further include receiving, in the bitstream, a second indication of a type of DIMD mode being selected. In some examples, the determining the first HoG and the second HoG may further be based on the second indication of the type of DIMD mode. In some examples, the second indication of the type of DIMD mode may further indicate a merged HoG type of DIMD mode for predicting the current block.

At 3104, the decoder determines, based on the first indication, a first histogram of gradients (HoG) based on the current block and a second HoG based on a neighboring block of the current block. In some examples, the determining, based on the first indication, the first HoG may further be based on a template of the current block. In some examples, the determining, based on the first indication, the first HoG may further be based on reference samples of the current block. In some examples, the second HoG may comprise a HoG determined for the neighboring block. In some examples, the second HoG may be determined based on combining HoGs of neighboring blocks of the current block. In some examples, the neighboring block may be associated with the DIMD prediction mode. In some examples, the neighboring block may comprise a previously decoded block. In some examples, the neighboring blocks may be associated with the DIMD prediction mode.

At 3106, the decoder determines a value representing a similarity between the first HoG and the second HoG. In some examples, the determining the value representing the similarity may further comprise determining a set of differences between amplitudes of first bins of the first HoG and amplitudes of second bins, corresponding to the first bins, of the second HoG. In some examples, the determining the value representing the similarity may further comprise calculating a Minkowski distance between first bins of the first HoG and second bins, corresponding to the first bins, of the second HoG. In some examples, the calculating the Minkowski distance may further comprise determining a set of differences between first amplitudes of the first bins of the first HoG and second amplitudes of the second bins of the second HoG. In some examples, the first bins and the second bins may comprise angular intra prediction modes (IPMs). In some examples, the set of differences between the amplitudes of the first bins of the first HoG and the amplitudes of the second bins, corresponding to the first bins, of the second HoG may correspond to a same angular prediction mode.

At 3108, the decoder selects, for the DIMD prediction mode and based on comparing the value with a threshold value, a set of parameters from a first set of parameters and a second set of parameters. In some examples, the first set of parameters may comprise a reference line adjacent to the current block, and the second set of parameters may comprise a reference line, from multiple reference lines (MRLs), that is not adjacent to the current block. In some examples, the first set of parameters may comprise a first weight for a planar mode, and the second set of parameters may comprise a second weight, different from the first weight, for the planar mode. In some examples, the decoder may further determine the DIMD predictor based on a linear combination of the planar mode and intra prediction modes (IPMs) selected from the HoG indicated by the first indication. In some examples, the linear combination may comprise a weight, selected from the first weight and the second weight, for the planar mode. In some examples, the linear combination may further comprise weights corresponding to the IPMs determined based on DIMD costs of the IPMs.

At 3110, the decoder generates a DIMD predictor based on the set of parameters. In some examples, the generating the DIMD predictor based on the set of parameters may further be based on one of the first HoG and the second HoG indicated by the first indication. In some examples, the generating the DIMD predictor based on the set of parameters may further be based on one of the first HoG and the second HoG indicated by the first indication and the second indication.

And, at 3112, the decoder decodes the current block based on the DIMD predictor. In some examples, the decoder may further receive, in the bitstream, a residual block. In some examples, the decoding the current block based on the DIMD predictor may further comprise combining a prediction block corresponding to the DIMD predictor with the residual block.

FIG. 32 shows a flowchart 3200 of a method for diversifying decoder-side intra mode derivation (DIMD) merge candidates by an encoder, according to some embodiments. The method of flowchart 3200 may be implemented by an encoder, such as encoder 200 in FIG. 2.

The method of flowchart 3200 begins at 3202. At 3202, an encoder determines a decoder-side intra mode derivation (DIMD) prediction mode for encoding a current block.

At 3204, the encoder encodes, in a bitstream, a first indication of the DIMD prediction mode. In some examples, the encoding, in the bitstream, the first indication of the DIMD prediction mode further comprises encoding, in the bitstream, a second indication of a type of DIMD mode being selected.

At 3206, the encoder determines, based on the first indication, a first histogram of gradients (HoG) based on the current block and a second HoG based on a neighboring block of the current block. In some examples, the determining the first HoG and the second HoG is further based on the second indication of the type of DIMD mode. In some examples, the second indication of the type of DIMD mode may further indicate a merged HoG type of DIMD mode for encoding the current block. In some examples, the determining, based on the first indication, the first HoG may further be based on a template of the current block. In some examples, the determining, based on the first indication, the first HoG may further be based on reference samples of the current block. In some examples, the second HoG may comprise a HoG determined for the neighboring block. In some examples, the second HoG may be determined based on combining HoGs of neighboring blocks of the current block. In some examples, the neighboring block may be associated with the DIMD prediction mode. In some examples, the neighboring block may comprise a previously reconstructed block. In some examples, the neighboring blocks may be associated with the DIMD prediction mode.

At 3208, the encoder determines a value representing a similarity between the first HoG and the second HoG. In some examples, the determining the value representing the similarity may further comprise determining a set of differences between amplitudes of first bins of the first HoG and amplitudes of second bins, corresponding to the first bins, of the second HoG. In some examples, the determining the value representing the similarity may further comprise calculating a Minkowski distance between first bins of the first HoG and second bins, corresponding to the first bins, of the second HoG. In some examples, the calculating the Minkowski distance may further comprise determining a set of differences between first amplitudes of the first bins of the first HoG and second amplitudes of the second bins of the second HoG. In some examples, the first bins and the second bins may comprise angular intra prediction modes (IPMs). In some examples, the set of differences between the amplitudes of the first bins of the first HoG and the amplitudes of the second bins, corresponding to the first bins, of the second HoG may correspond to a same angular prediction mode.

At 3210, the encoder selects, for the DIMD prediction mode and based on comparing the value with a threshold value, a set of parameters from a first set of parameters and a second set of parameters. In some examples, the first set of parameters may comprise a reference line adjacent to the current block, and the second set of parameters may comprise a reference line, from multiple reference lines (MRLs), that is not adjacent to the current block. In some examples, the first set of parameters may comprise a first weight for a planar mode, and the second set of parameters may comprise a second weight, different from the first weight, for the planar mode. In some examples, the encoder may further determine the DIMD predictor based on a linear combination of the planar mode and intra prediction modes (IPMs) selected from the HoG indicated by the first indication. In some examples, the linear combination may comprise a weight, selected from the first weight and the second weight, for the planar mode. In some examples, the linear combination may further comprise weights corresponding to the IPMs determined based on DIMD costs of the IPMs.

At 3212, the encoder generates a DIMD predictor based on the set of parameters. In some examples, the generating the DIMD predictor based on the set of parameters may further be based on one of the first HoG and the second HoG indicated by the first indication. In some examples, the generating the DIMD predictor based on the set of parameters may further be based on one of the first HoG and the second HoG indicated by the first indication and the second indication.

And, at 3214, the encoder encodes the current block based on the DIMD predictor. In some examples, the encoder may further determine a residual block based on the current block and a prediction block corresponding to the DIMD predictor. In some examples, the encoder may further encode, in the bitstream, the residual block.

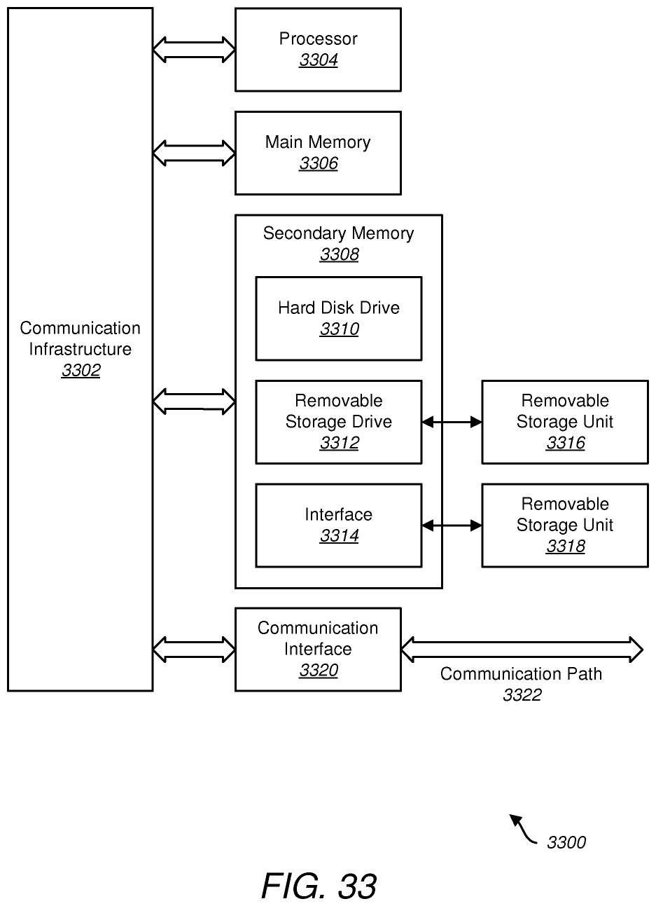

Embodiments of the present disclosure may be implemented in hardware using analog and/or digital circuits, in software, through the execution of instructions by one or more general purpose or special-purpose processors, or as a combination of hardware and software. Consequently, embodiments of the disclosure may be implemented in the environment of a computer system or other processing system. An example of such a computer system 3300 is shown in FIG. 33. Blocks depicted in the figures above, such as the blocks in FIGS. 1, 2, and 3, may execute on one or more computer systems 3300. Furthermore, each of the steps of the flowcharts depicted in this disclosure may be implemented on one or more computer systems 3300.

Computer system 3300 includes one or more processors, such as processor 3304. Processor 3304 may be, for example, a special purpose processor, general purpose processor, microprocessor, or digital signal processor. Processor 3304 may be connected to a communication infrastructure 3302 (for example, a bus or network). Computer system 3300 may also include a main memory 3306, such as random access memory (RAM), and may also include a secondary memory 3308.

Secondary memory 3308 may include, for example, a hard disk drive 3310 and/or a removable storage drive 3312, representing a magnetic tape drive, an optical disk drive, or the like. Removable storage drive 3312 may read from and/or write to a removable storage unit 3316 in a well-known manner. Removable storage unit 3316 represents a magnetic tape, optical disk, or the like, which is read by and written to by removable storage drive 3312. As will be appreciated by persons skilled in the relevant art(s), removable storage unit 3316 includes a computer usable storage medium having stored therein computer software and/or data.

In alternative implementations, secondary memory 3308 may include other similar means for allowing computer programs or other instructions to be loaded into computer system 3300. Such means may include, for example, a removable storage unit 3318 and an interface 3314. Examples of such means may include a program cartridge and cartridge interface (such as that found in video game devices), a removable memory chip (such as an EPROM or PROM) and associated socket, a thumb drive and USB port, and other removable storage units 3318 and interfaces 3314 which allow software and data to be transferred from removable storage unit 3318 to computer system 3300.

Computer system 3300 may also include a communications interface 3320. Communications interface 3320 allows software and data to be transferred between computer system 3300 and external devices. Examples of communications interface 3320 may include a modem, a network interface (such as an Ethernet card), a communications port, etc. Software and data transferred via communications interface 3320 are in the form of signals which may be electronic, electromagnetic, optical, or other signals capable of being received by communications interface 3320. These signals are provided to communications interface 3320 via a communications path 3322. Communications path 3322 carries signals and may be implemented using wire or cable, fiber optics, a phone line, a cellular phone link, an RF link, and other communications channels.

As used herein, the terms “computer program medium” and “computer readable medium” are used to refer to tangible storage media, such as removable storage units 3316 and 3318 or a hard disk installed in hard disk drive 3310. These computer program products are means for providing software to computer system 3300. Computer programs (also called computer control logic) may be stored in main memory 3306 and/or secondary memory 3308. Computer programs may also be received via communications interface 3320. Such computer programs, when executed, enable the computer system 3300 to implement the present disclosure as discussed herein. In particular, the computer programs, when executed, enable processor 3304 to implement the processes of the present disclosure, such as any of the methods described herein. Accordingly, such computer programs represent controllers of the computer system 3300.

In another embodiment, features of the disclosure may be implemented in hardware using, for example, hardware components such as application-specific integrated circuits (ASICs) and gate arrays. Implementation of a hardware state machine to perform the functions described herein will also be apparent to persons skilled in the art.

What is claimed is:

1. A method comprising:
decoding, from a bitstream for a current block:
a first indication of decoder-side intra mode derivation (DIMD) prediction being enabled; and
a second indication of a DIMD prediction mode being selected from a plurality of DIMD prediction modes;
determining, based on the first indication and the second indication:
a first histogram of gradients (HoG) based on a template of the current block; and
a second HoG based on a plurality of neighboring blocks of the current block;
determining a value representing a similarity between the first HoG and the second HoG;
selecting, for the DIMD prediction mode and based on comparing the value with a threshold value, a set of parameters from a first set of parameters and a second set of parameters; and
decoding the current block using a DIMD predictor generated based on the selected set of parameters.

2. The method of claim 1, wherein the plurality of DIMD prediction modes comprises:
a first DIMD prediction mode associated with the first HoG; and
a second DIMD prediction mode associated with the second HoG, wherein the selected DIMD prediction mode is the second DIMD prediction mode.

3. The method of claim 1, wherein the first set of parameters is associated with the selected DIMD prediction mode, and wherein:
the value being less than the threshold value indicates the set of parameters being selected as the first set of parameters; and
the value being greater than or equal to the threshold value indicates the set of parameters being selected as the second set of parameters.

4. The method of claim 1, wherein the determining the value representing the similarity comprises:
determining a set of differences between amplitudes of first bins of the first HoG and amplitudes of second bins, corresponding to the first bins, of the second HoG, wherein the first and second bins correspond to angular intra prediction modes (IPMs).

5. The method of claim 1, wherein the first set of parameters comprises a reference line adjacent to the current block, and wherein the second set of parameters comprises a reference line, from multiple reference lines (MRLs), that is not adjacent to the current block.

6. The method of claim 1, wherein the first set of parameters comprises a first weight for a planar mode, and wherein the second set of parameters comprises a second weight different from the first weight.

7. The method of claim 1, wherein the DIMD predictor is determined based on a linear combination of intra prediction modes (IPMs) selected from one of the first or second HoG indicated by the first and second indications.

8. A decoder comprising:
one or more processors; and
memory storing instructions that, when executed by the one or more processors, cause the decoder to:
decode, from a bitstream for a current block:
a first indication of decoder-side intra mode derivation (DIMD) prediction being enabled; and
a second indication of a DIMD prediction mode being selected from a plurality of DIMD prediction modes;
determine, based on the first indication and the second indication:
a first histogram of gradients (HoG) based on a template of the current block; and
a second HoG based on a plurality of neighboring blocks of the current block;
determine a value representing a similarity between the first HoG and the second HoG;
select, for the DIMD prediction mode and based on comparing the value with a threshold value, a set of parameters from a first set of parameters and a second set of parameters; and
decode the current block using a DIMD predictor generated based on the selected set of parameters.

9. The decoder of claim 8, wherein the plurality of DIMD prediction modes comprises:
a first DIMD prediction mode associated with the first HoG; and
a second DIMD prediction mode associated with the second HoG, wherein the selected DIMD prediction mode is the second DIMD prediction mode.

10. The decoder of claim 8, wherein the first set of parameters is associated with the selected DIMD prediction mode, and wherein:
the value being less than the threshold value indicates the set of parameters being selected as the first set of parameters; and
the value being greater than or equal to the threshold value indicates the set of parameters being selected as the second set of parameters.

11. The decoder of claim 8, wherein to determine the value representing the similarity, the instructions further cause the decoder to:
determine a set of differences between amplitudes of first bins of the first HoG and amplitudes of second bins, corresponding to the first bins, of the second HoG, wherein the first and second bins correspond to angular intra prediction modes (IPMs).

12. The decoder of claim 8, wherein the first set of parameters comprises a reference line adjacent to the current block, and wherein the second set of parameters comprises a reference line, from multiple reference lines (MRLs), that is not adjacent to the current block.

13. The decoder of claim 8, wherein the first set of parameters comprises a first weight for a planar mode, and wherein the second set of parameters comprises a second weight different from the first weight.

14. The decoder of claim 8, wherein the DIMD predictor is determined based on a linear combination of intra prediction modes (IPMs) selected from one of the first or second HoG indicated by the first and second indications.

15. A non-transitory computer-readable medium comprising instructions that, when executed by one or more processors of a decoder, causes the decoder to:
decode, from a bitstream for a current block:
a first indication of decoder-side intra mode derivation (DIMD) prediction being enabled; and
a second indication of a DIMD prediction mode being selected from a plurality of DIMD prediction modes;
determine, based on the first indication and the second indication:
a first histogram of gradients (HoG) based on a template of the current block; and
a second HoG based on a plurality of neighboring blocks of the current block;
determine a value representing a similarity between the first HoG and the second HoG;
select, for the DIMD prediction mode and based on comparing the value with a threshold value, a set of parameters from a first set of parameters and a second set of parameters; and
decode the current block using a DIMD predictor generated based on the selected set of parameters.

16. The non-transitory computer-readable medium of claim 15, wherein the plurality of DIMD prediction modes comprises:
a first DIMD prediction mode associated with the first HoG; and
a second DIMD prediction mode associated with the second HoG, wherein the selected DIMD prediction mode is the second DIMD prediction mode.

17. The non-transitory computer-readable medium of claim 15, wherein the first set of parameters is associated with the selected DIMD prediction mode, and wherein:
the value being less than the threshold value indicates the set of parameters being selected as the first set of parameters; and
the value being greater than or equal to the threshold value indicates the set of parameters being selected as the second set of parameters.

18. The non-transitory computer-readable medium of claim 15, wherein to determine the value representing the similarity, the instructions further cause the decoder to:
determine a set of differences between amplitudes of first bins of the first HoG and amplitudes of second bins, corresponding to the first bins, of the second HoG, wherein the first and second bins correspond to angular intra prediction modes (IPMs).

19. The non-transitory computer-readable medium of claim 15, wherein:
the first set of parameters comprises a reference line adjacent to the current block, and the second set of parameters comprises a reference line, from multiple reference lines (MRLs), that is not adjacent to the current block; or
the first set of parameters comprises a first weight for a planar mode, and the second set of parameters comprises a second weight different from the first weight.

20. The non-transitory computer-readable medium of claim 15, wherein the DIMD predictor is determined based on a linear combination of intra prediction modes (IPMs) selected from one of the first or second HoG indicated by the first and second indications.
